(19) United States
(12) Patent Application Publication
(10) Pub. No.: US 2005/0212663 A1
(43) Pub. Date: Sep. 29, 2005

(54) Equipment installation-place setting system, equipment control apparatus, electrical equipment, equipment installation-place setting method and computer-readable record medium storing equipment installation-place setting program

(76) Inventors: Michihiro Matsumoto, Joyo-shi (JP); Takahiko Kamitsuji, Ibaraki-shi (JP); Hidetoshi Takubo, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/085,506

(22) Filed: Mar. 22, 2005

(30) Foreign Application Priority Data
Mar. 23, 2004 (JP) 2004-084354(PAT.)

(51) Int. Cl. G08B 1/00

(52) U.S. Cl. 340/309.6

(57) ABSTRACT

An equipment installation-place setting system is provided which is capable of easily registering, in a database, the installation place of equipment that is newly installed. In this system: a controller receives, from a newly-installed household electrical appliance, the ID of another household electrical appliance which is located within a predetermined range from the newly-installed household electrical appliance; from a database in which equipment information is stored that indicates the ID and installation-place information on a household electrical appliance, the installation-place information is retrieved which corresponds to the ID of another household electrical appliance; based on the ID and installation-place information on another household electrical appliance, the installation-place information on the newly-installed household electrical appliance is predicted; and the predicted installation-place information is displayed.

### BACKGROUND OF THE INVENTION

1. Field of the Invention

The present invention relates to an equipment installation-place setting system which sets an installation place of electrical equipment that is newly installed. It also relates to an equipment control apparatus, electrical equipment, an equipment installation-place setting method and a computer-readable record medium storing equipment installation-place setting program for the same purpose.

2. Description of the Related Art

Conventionally, in the case where data is transmitted to arbitrary equipment in network communication, an ID which is uniquely assigned to each piece of equipment is designated as a destination. Such an ID includes a MAC address, an IP address and the like. However, it is difficult for a person who uses equipment (hereinafter, referred to as the user) to recognize an ID. This requires a database which relates installation-place information to an ID, and the function of translating the ID using the installation-place information and the name of equipment. Thereby, the user can designate the equipment, using the place and the name of equipment (e.g., refer to Japanese Unexamined Patent Publication No. 2002-291039 specification).

However, in this method, an ID and installation-place information needs to be related and registered in a database. In the above described prior art, the user inputs the ID of equipment and the installation-place information, so that they can be entered in a database. Such an input operation is burdensome work for the user, thus making the operation complicated.

### SUMMARY OF THE INVENTION

It is an object of the present invention to provide equipment installation-place information processing technology which is free from the problems residing in the prior art.

It is another object of the present invention to provide an equipment installation-place setting system which is capable of easily registering, in a database, installation place of newly-installed equipment.

It is still another object of the present invention to provide an equipment control apparatus, electrical equipment, an equipment installation-place setting method and a computer-readable record medium storing equipment installation-place setting program which can ensure easier registration of installation place of newly-installed equipment in database.

According to an aspect of the present invention, identification information of one electrical equipment is transmitted to equipment control apparatus by way of another electrical equipment which is in a predetermined range from the one electrical equipment. Installation-place information of the one electrical equipment is retrieved based on the transmitted identification information of the one electrical equipment. The installation-place of the other electrical equipment is predicted based on the identification information and the installation-place information of the one electrical equipment.

These and other objects, features and advantages of the present invention will become more apparent upon reading of the following detailed description along with the accompanied drawings.

### BRIEF DESCRIPTION OF THE DRAWINGS

FIG. 1 is an illustration, showing an example of a household-appliance network system according to a first embodiment of the present invention.

FIG. 2 is a table, showing an example of a data list which is stored in a database.

FIG. 3 is a block diagram, showing the function of a household electrical appliance which configures the household-appliance network system.

FIG. 4 is a block diagram, showing the function of a controller which configures the household-appliance network system.

FIG. 5 is a flow chart, showing an example of an installation-information registration processing which is executed by a household electrical appliance that is newly installed.

FIG. 6 is a flow chart, showing an example of an installation-information registration processing which is executed by the controller.

FIG. 7 is a block diagram, showing the function of the controller in the case where the database is built in the controller.

FIG. 8 is an illustration, showing an example of a household-appliance network system according to a second embodiment of the present invention.

FIG. 9 is a block diagram, showing the function of reference equipment according to the second embodiment.

FIG. 10 is a table, showing an example of a data list which is stored in a database according to the second embodiment.

FIG. 11 is an illustration, showing an example of a household-appliance network system according to a third embodiment of the present invention.

FIG. 12 is a block diagram, showing the function of a controller which configures the household-appliance network system according to the third embodiment.

FIG. 13 is a block diagram, showing the function of a household electrical appliance which configures the household-appliance network system according to the third embodiment.

FIG. 14 is a flow chart, showing an example of a registration-start processing which is executed by the controller.

FIG. 15 is a flow chart, showing an example of an installation-information registration processing which is executed by a household electrical appliance that is newly installed.

FIG. 16 is a block diagram, showing the function of a controller which configures a household-appliance network system according to a fourth embodiment of the present invention.

FIGS. 17A and 17B are representations, showing layout information according to the fourth embodiment.

FIG. 18 is a representation, showing layout information according to a variation of the fourth embodiment.

### DETAILED DESCRIPTION OF THE PREFERRED EMBODIMENTS OF THE INVENTION

Hereinafter, embodiments of the present invention will be described with reference to the drawings.

### First Embodiment

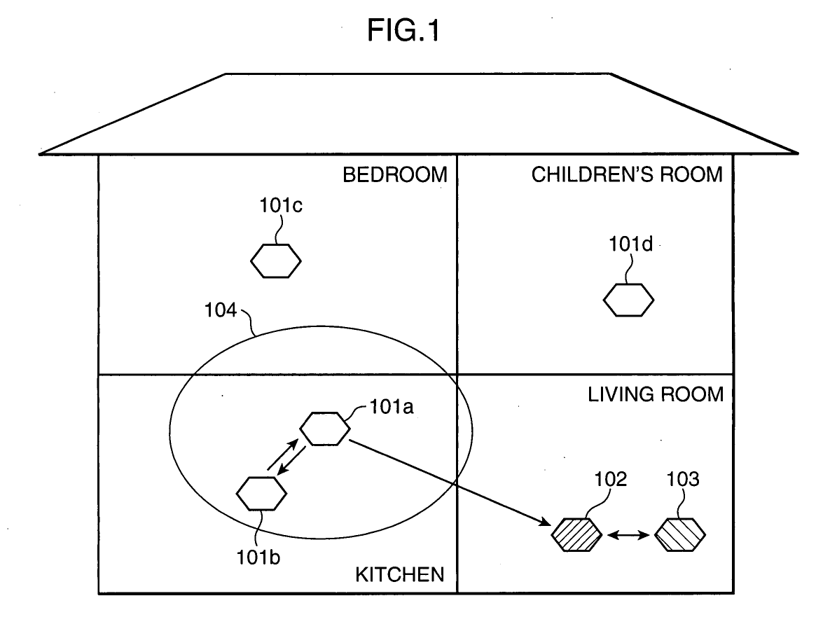

FIG. 1 is an illustration, showing an example of a household-appliance network system according to the present invention. In FIG. 1, the household-appliance network system according to a first embodiment of the present invention is configured by: several household electrical appliances 101a to 101d; a controller (or an equipment control apparatus) 102; and a database 103. The several household electrical appliances 101a to 101d, the controller 102 and the database 103 are installed in a house, an apartment, or the like. The controller 102 is communicably connected to the household electrical appliances 101a to 101d and the database 103, through a communication line in a house. It transmits a control instruction to the household electrical appliances 101a to 101d. Thereby, it controls the operation of the household electrical appliances 101a to 101d and monitors the state of the household electrical appliances 101a to 101d. A communicable range 104 is a range where the household electrical appliance 101a can communicate in the case where transmission power is kept down (described later).

Herein, the household electrical appliances 101a to 101d in this household-appliance network system are so-called home electrical appliances, such as an air conditioner, a refrigerator, a washing machine and a microwave oven. However, the present invention is not limited especially to this. Specifically, equipment which can be connected to a home network may also be used, including a home electrical appliance, as well as a housing equipment, a sensor which measures and detects a housing environment, and the like. In the present specification, “electrical equipment” is used as the general term for these pieces of equipment.

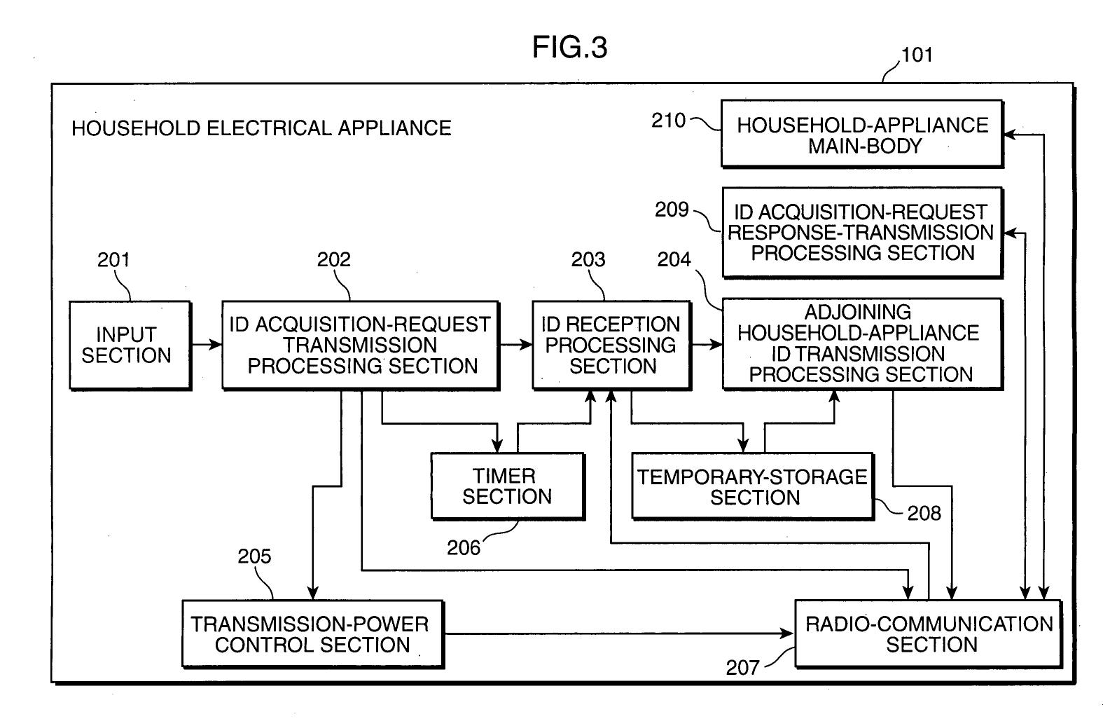

The household electrical appliances 101a to 101d each include a radio communication section 207 (see FIG. 3), such as the Bluetooth and a low-power radio conforming to the ARIB standard. The household electrical appliance 101a is a home appliance which is freshly installed. The household electrical appliance 101b is a home appliance which is installed near the newly-installed household electrical appliance 101a. It is within the range (or within the communicable range 104) in which the newly-installed household electrical appliance 101a can communicate by radio with its transmission power kept restrained. The household electrical appliances 101c, 101d are each a home appliance which is installed apart from the newly-installed household electrical appliance 101a. It is within the range (or out of the communicable range 104) where the newly-installed household electrical appliance 101a cannot communicate by radio with its transmission power kept restrained. The database 103 stores a data list which is made up of the ID (or identification information) of a home appliance which is already installed, and installation-place information on the home appliance.

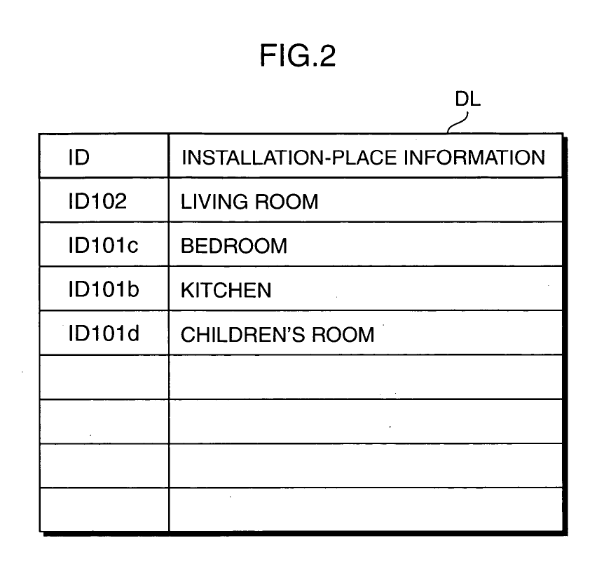

FIG. 2 is a table, showing an example of a data list which is stored in the database 103. As shown in a data list DL of FIG. 2, in the database 103, an ID which is identification information on a home appliance, and installation-place information which indicates the installation place of the home appliance, are stored in the way that they correspond to each other. FIG. 2 shows the state before the household electrical appliance 101a is installed. An ID102 is an ID of the controller 102. The controller 102 is in a living room, and thus, as the installation-place information, data which is called a living room corresponds to the ID102. An ID101c is an ID of the household electrical appliance 101c. The household electrical appliance 101c is in a bedroom, and thus, as the installation-place information, data which is called a bedroom corresponds to the IDc. Similarly, the installation-place information which is called a kitchen and a room for a child corresponds to an ID101b and an ID101d, respectively. Herein, in the data list DL shown in FIG. 2, only installation-place information on a home appliance corresponds to an ID of the home appliance. However, data except that may also correspond to an ID of the home appliance. For example, such data includes data which shows the kind of a home appliance such as an air conditioner, data which shows the name of a manufacturer of the home appliance, and the like. Herein, according to the configuration of FIG. 1, only one controller is provided, but several controllers may also be provided.

FIG. 3 is a block diagram, showing the function of a household electrical appliance 101 which configures the household-appliance network system which the present invention is applied to. Herein, each household electrical appliance 101a to 101d has the same configuration, and thus, these household electrical appliances 101a to 101d are generically referred to as the household electrical appliance 101. In FIG. 3, the household electrical appliance 101 is configured by: an input section 201; an ID acquisition-request transmission processing section 202; an ID reception processing section 203; an adjoining household-appliance ID transmission processing section 204; a transmission-power control section 205; a timer section 206; a radio-communication section 207; a temporary-storage section 208; an ID acquisition-request response-transmission processing section 209; and a household-appliance main-body 210.

The input section 201 outputs a start trigger for starting a setting-position information registration processing when a home electrical appliance is installed. If the start trigger is inputted from the input section 201, the ID acquisition-request transmission processing section 202 creates a packet (i.e., an ID acquisition-request packet) which makes a request to acquire an ID, and broadcasts it. The temporary-storage section 208 temporarily stores an ID which is included in a response packet from the home electrical appliance that replies to the ID acquisition-request packet which has been transmitted by the ID acquisition-request transmission processing section 202. While a condition is being met for an ID-reception standby, the ID reception processing section 203 retrieves an ID from the response packet from the home electrical appliance that replies to the ID acquisition-request packet which has been transmitted by the ID acquisition-request transmission processing section 202. Then, it stores the ID in the temporary-storage section 208.

The adjoining household-appliance ID transmission processing section 204 transmits, to the controller 102, the ID which has been stored in temporary-storage section 208. The timer section 206 notifies the ID reception processing section 203 that a certain period of time has passed since the ID acquisition-request transmission processing section 202 transmitted the ID acquisition-request packet. The radio-communication section 207 is connected to a home-appliance network, so that it can transmit and receive various kinds of data. Herein, as a specific example of the home-appliance network, there are mentioned a low-power radio conforming to the ARIB standard, the Bluetooth, and the like. The transmission-power control section 205 controls the transmission power of the radio-communication section 207. The ID acquisition-request response-transmission processing section 209 transmits the response packet if it has received the ID acquisition-request packet. The household-appliance main-body 210 fulfills the function of a household appliance itself. For example, if the household electrical appliance 101 is a TV, the household-appliance main-body 210 corresponds to the part which receives and demodulates a broadcast radio-wave and displays a picture. If the household electrical appliance 101 is an air conditioner, the household-appliance main-body 210 is equivalent to the part which raises or drops the temperature by heat exchange. The control instruction which has been transmitted by the controller 102 is sent through the radio-communication section 207 to the household-appliance main-body 210.

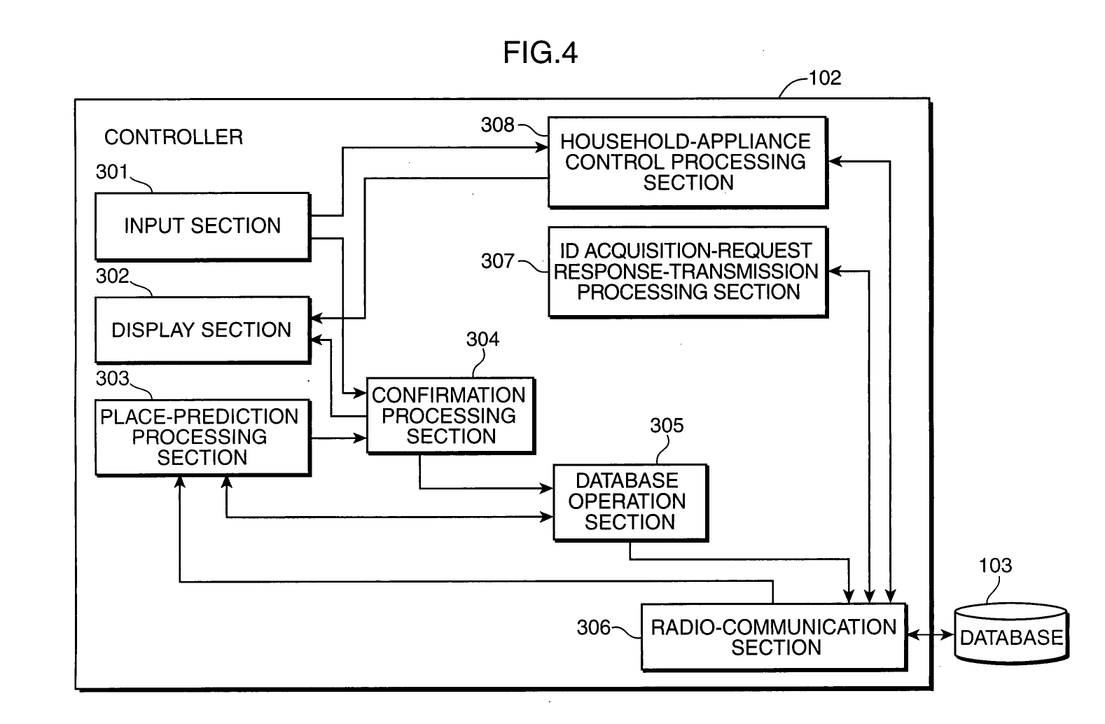

FIG. 4 is a block diagram, showing the function of the controller 102 which configures the household-appliance network system. In FIG. 4, the controller 102 is configured by: an input section 301; a display section 302; a place-prediction processing section 303; a confirmation processing section 304; a database operation section 305; a radio-communication section 306; an ID acquisition-request response-transmission processing section 307; and a household-appliance control processing section 308.

The radio-communication section 306 is connected to a home-appliance network, so that it can transmit and receive various kinds of data. Herein, as a specific example of the home-appliance network, there are mentioned a low-power radio conforming to the ARIB standard, the Bluetooth, and the like. The place-prediction processing section 303 receives, from the newly-installed household electrical appliance 101a, an ID on a home appliance which is installed near the newly-installed household electrical appliance 101a. Based on the ID, it predicts the installation place of the newly-installed household electrical appliance 101a. The display section 302 displays a candidate of installation-place information which has been predicted by the place-prediction processing section 303.

After the user confirms the candidate of installation-place information which has been displayed in the display section 302, the input section 301 accepts a confirmation input of a modification input by the user. The confirmation processing section 304 outputs, to the display section 302, the candidate of installation-place information which has been predicted by the place-prediction processing section 303. Thereby, it asks the user to confirm it, and then, it executes the confirmation using input information from the input section 301. The database operation section 305 registers data in the database 103, reads data from the database 103, or does another such. The ID acquisition-request response-transmission processing section 307 transmits a response packet if it receives an ID acquisition-request packet which has been transmitted by the household electrical appliance 101. The household-appliance control processing section 308 controls the household electrical appliance 101. For example, the household-appliance control processing section 308 controls an air conditioner by sending a cooling-operation instruction or a heating-operation instruction to the air conditioner. Or, it acquires the temperature inside of a refrigerator from the refrigerator and displays it in the display section 302.

According to this embodiment, the ID acquisition-request transmission processing section 202 corresponds to an example of the acquisition-request transmission section; the ID reception processing section 203, to an example of the identification-information reception section; the adjoining household-appliance ID transmission processing section 204, to an example of the identification-information transmission section; and the ID acquisition-request packet, to an example of the identification-information acquisition request.

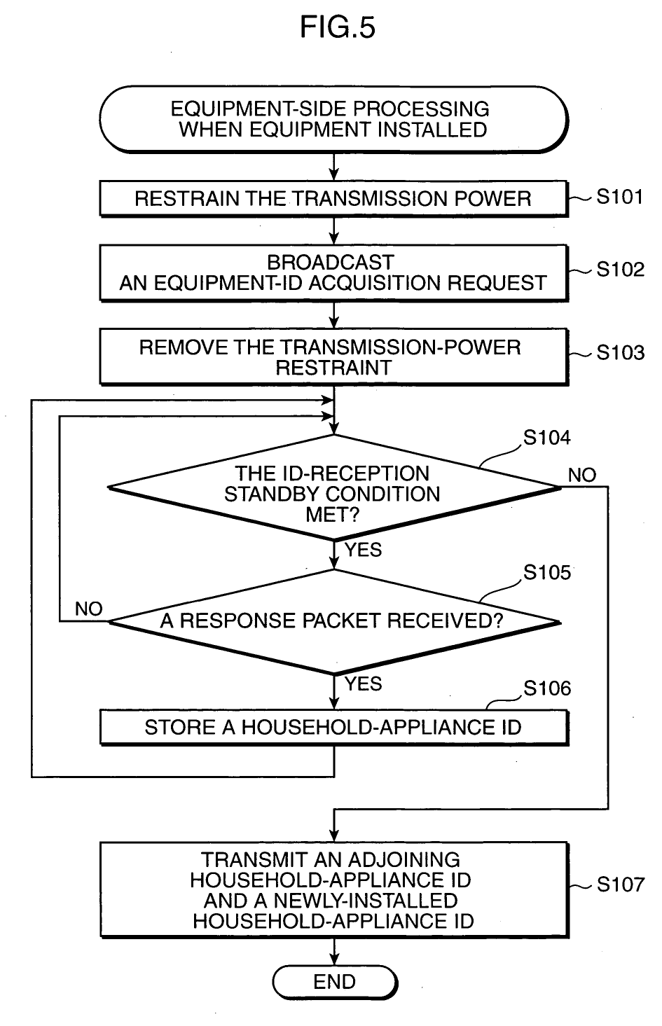

Next, in the case where a home appliance is installed afresh, an installation-information registration processing will be described in the household electrical appliance 101 according to the first embodiment. FIG. 5 is a flow chart, showing an example of an installation-information registration processing which is executed by a newly-installed household electrical appliance.

First, the input section 201 of the newly-installed household electrical appliance 101a accepts an instruction to start an installation-information registration processing by the user. Then, the input section 201 of the newly-installed household electrical appliance 101a instructs the ID acquisition-request transmission processing section 202 to start its operation. The ID acquisition-request transmission processing section 202 instructs the transmission-power control section 205 to restrain a transmission power. The transmission-power control section 205 controls the radio-communication section 207, so that the transmission power can be kept down (in Step S101). It is preferable that the transmission power has a communication distance which is substantially equivalent to the measurements of a room where the newly-installed household electrical appliance 101a is installed. For example, if the measurements of such a room is 5 m×5 m, it controls the transmission power so that the communication distance becomes approximately five meters. The relation between the communication distance and the transmission power differ according to the communication standards of the radio-communication section 207. If the communication standards of the radio-communication section 207 is the Bluetooth, the transmission power needs to be, at least, less than 1 mw. This is because in the Bluetooth, the communicable distance is 10m at a transmission power of 1 mw.

Next, the ID acquisition-request transmission processing section 202 creates a packet (i.e., an ID acquisition-request packet) which makes a request to acquire an ID, and broadcasts the packet via the radio-communication section 207. Then, it allows the timer section 206 and the ID reception processing section 203 to operate (in Step S102). Sequentially, the ID acquisition-request transmission processing section 202 returns, to an ordinary transmission power, the transmission power of the radio-communication section 207 which has been restrained by the transmission-power control section 205 (in Step S103).

Next, the ID reception processing section 203 decides whether a time-out notification has been received from the timer section 206 (in Step S104). If the decision is made that the time-out notification has been received from the timer section 206, the condition for an ID-reception standby is regarded as not having been met. Thus, the processing shifts to Step S107 (described later) (NO at Step S104). On the other hand, if the decision is made that the time-out notification has not been received from the timer section 206, the ID-reception standby condition is regarded as having been met. Thus, the processing shifts to Step S105 (described later) (YES at Step S104).

If the ID-reception standby condition is met, or if the decision is made that the time-out notification has not been received, in Step S105, the ID reception processing section 203 decides whether a response packet to an ID acquisition request has been received from another node (i.e., another household electrical appliance) in the radio-communication section 207. If it has not been received, the processing returns to Step S104 (NO at Step S105). On the other hand, if it has been received, the processing moves ahead to Step S106 (YES at Step S105). If the decision is made that the response packet has been received, then in Step S106, the ID reception processing section 203 acquires an ID of an already-installed household electrical appliance from a response electronic document (i.e., the response packet) which has been received from the radio-communication section 207. Then, it stores the ID in the temporary-storage section 208. After the ID is stored, the processing returns to Step S104.

On the other hand, if the ID-reception standby condition is not met, or if the decision is made that the time-out notification has been received, in Step S107, the ID reception processing section 203 allows the adjoining household-appliance ID transmission processing section 204 to start operating. The adjoining household-appliance ID transmission processing section 204 acquires, from the temporary-storage section 208, the ID of an adjoining household electrical appliance which has been stored in Steps S104 to S106. Then, it transmits it, together with the ID of the newly-installed household electrical appliance itself, through the radio-communication section 207 to the controller 102. If there is no already-installed household electrical appliance around it, or if the ID of an adjoining household electrical appliance is not stored in the temporary-storage section 208, the adjoining household-appliance ID transmission processing section 204 notifies it of the ID of the newly-installed household electrical appliance itself and that there is no response to the ID acquisition request.

Herein, in Step S104, an example is shown in which a time-out notification from the timer section 206 is not received as the ID-reception standby condition. However, the present invention is not limited especially to this. As the ID-reception standby condition, a time-out notification from the timer section 206 may also be combined with another condition. For example, such a condition may also be that a time-out notification is not received from the timer section 206 and any number of responses to the ID acquisition-request packet are not received. In this condition, even before a time-out notification is received from the timer section 206, the processing shifts to Step S107 at the point of time when any number of response packets are received.

In this way, an identification-information acquisition request to acquire identification information (i.e., an ID) on another household electrical appliance, is transmitted broadcast. In response to the transmitted identification-information acquisition request, identification information on another household electrical appliance within a predetermined range is received. Then, a condition for receiving the identification information is set. While the set condition is being met, the received identification information on another household electrical appliance is transmitted to the controller 102.

Therefore, the identification information on another household electrical appliance can be acquired which is installed near the newly-installed household electrical appliance 101a. Then, this identification information is transmitted to the controller 102. Thereby, the installation place of the newly-installed household electrical appliance 101a can be predicted.

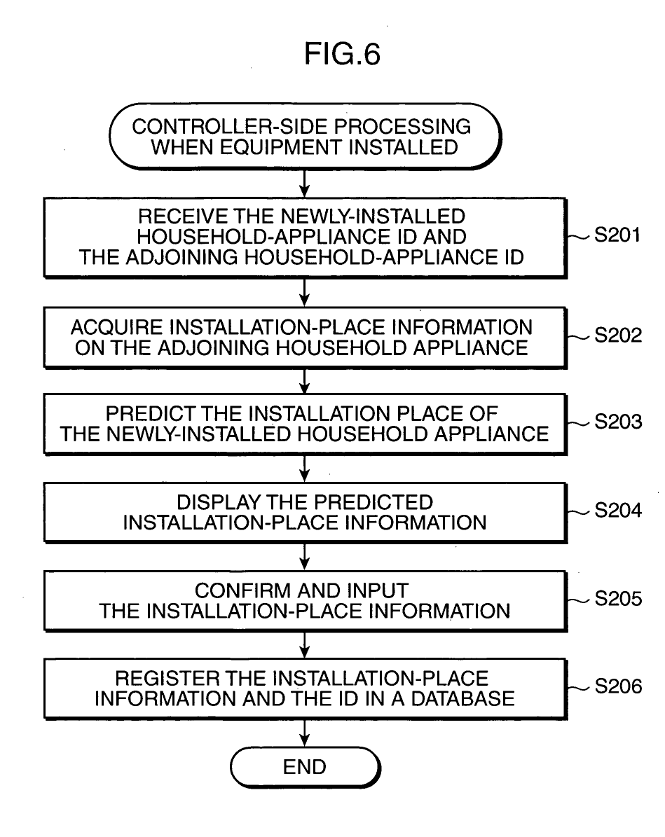

Next, in the case where a home appliance is installed afresh, an installation-information registration processing will be described for the controller 102 according to the first embodiment. FIG. 6 is a flow chart, showing an example of an installation-information registration processing which is executed by a controller.

First, the radio-communication section 306 of the controller 102 receives the ID of the newly-installed household electrical appliance itself and the ID of the adjoining household electrical appliance (in Step S201). If the ID of the newly-installed household electrical appliance and the ID of the adjoining household electrical appliance are received, the place-prediction processing section 303 of the controller 102 outputs, to the database operation section 305, the ID of the adjoining household electrical appliance which has been received in Step S201. The database operation section 305 accesses the database 103, via the radio-communication section 306. Then, it acquires installation-place information which is related to the ID of the adjoining household electrical appliance (in Step S202). The database operation section 305 outputs, to the place-prediction processing section 303, the installation-place information which has been acquired from the database 103.

Next, the place-prediction processing section 303 chooses one among the pieces of installation-place information which have been acquired in Step S202. Then, it outputs, to the confirmation processing section 304, the piece of installation-place information it has chosen. The place-prediction processing section 303 sums up the pieces of installation-place information and chooses the largest number of pieces of installation-place information. For example, if there are three pieces of installation-place information on a living room and there is a piece of installation-place information on a bedroom, the place-prediction processing section 303 chooses the installation-place information on a living room. Herein, in Step S107 of FIG. 5, if the newly-installed household electrical appliance gives a notification that there is no response to the ID acquisition request, or that there is no adjoining household electrical appliance, the place-prediction processing section 303 outputs, to the confirmation processing section 304, the fact that the installation place cannot be predicted (in Step S203).

Next, the confirmation processing section 304 receives the installation-place information which has been outputted by the place-prediction processing section 303. Then, it allows the display section 302 to display the installation-place information, and is on standby for a confirmation input from the user (in Step S204). Next, the confirmation processing section 304 accepts the confirmation input for the installation-place information. The user confirms whether the installation-place information is correct which has been displayed in the display section 302. If it is correct, the user inputs an OK, using the input section 301. If it is not correct, or if the fact that it cannot be predicted is displayed, then using the input section 301, the user inputs the correct installation-place information (in Step S205).

If the OK is inputted in Step S205, the confirmation processing section 304 outputs, to the database operation section 305, the installation-place information which has been displayed in the display section 302, as well as the ID of the newly-installed household electrical appliance itself which has been received in Step S201. If the correct installation-place information is inputted in Step S205, the confirmation processing section 304 outputs, to the database operation section 305, the installation-place information which has been inputted by the input section 301, as well as the ID of the newly-installed household electrical appliance itself which has been received in Step S201. The database operation section 305 accesses the database 103, via the radio-communication section 306. Then, it registers, in the database 103, the installation-place information and the ID of the household electrical appliance which have been outputted by the confirmation processing section 304 (in Step S206).

In this way, identification information on another household electrical appliance which is located within a predetermined range from the newly-installed household electrical appliance 101a, is received by the household electrical appliance 101a. Then, the installation-place information which corresponds to the identification information on another household electrical appliance is retrieved from the database 103 which stores equipment information which indicates the identification information on the household electrical appliance and the installation-place information. Sequentially, installation-place information on the household electrical appliance 101a is predicted based on the identification information on another household electrical appliance and the retrieved installation-place information. Then, the predicted installation-place information is displayed.

Therefore, the installation place of the newly-installed household electrical appliance 101a can be predicted based on the identification information on a household electrical appliance which is installed near the newly-installed household electrical appliance 101a. Then, this identification information is transmitted to the controller 102. Thereby, the installation place of the newly-installed household electrical appliance 101a can be predicted. Then, a candidate for the predicted installation place is displayed. Thereby, there is no need for the user to become aware of identification information on equipment to be installed. In other words, all the user has to do is to confirm its installation place. In such a way, the disposition place of the newly-installed household electrical appliance 101a can be registered in the database 103.

In addition, among the pieces of installation-place information on another household electrical appliance which has been retrieved by the database operation section 305, the largest number of pieces of installation-place information is expected to be the installation-place information on the newly-installed household electrical appliance 101a. In other words, the greater the number of pieces of installation-place information becomes, the more likely the installation place becomes the same as the newly-installed household electrical appliance 101a. Therefore, among the retrieved installation places of another piece of electrical equipment, the most installation places are projected to be the installation place of the newly-installed household electrical appliance 101a.

Herein, the place-prediction processing section 303 chooses only the largest number of pieces of installation-place information. However, it may also choose a predetermined number of pieces of installation-place information in order of the larger number of pieces. Then, the chosen several pieces of installation-place information are displayed as candidates in the display section 302. In that case, the user chooses the correct installation-place information from among the several pieces of installation-place information which are displayed in the display section 302. Then, the user inputs it, using the input section 301.

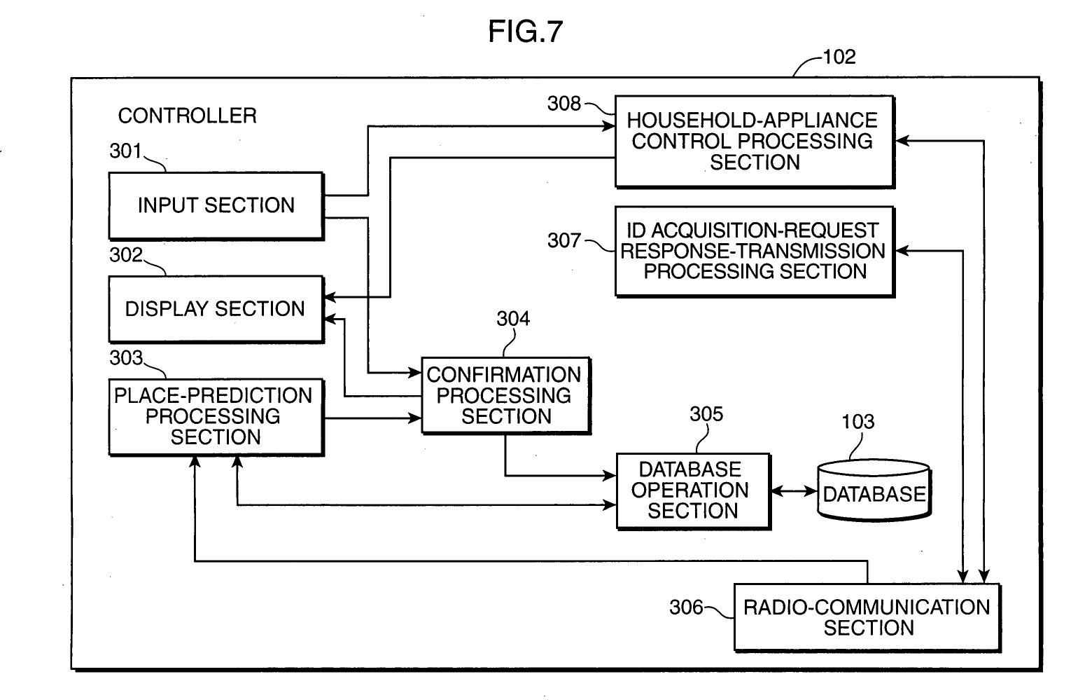

Furthermore, the database 103 may also be built in the controller 102. FIG. 7 is a block diagram, showing the function of the controller 102 in the case where a database is built in the controller 102. In this figure, description is omitted about the parts which are common to those of FIG. 4. In FIG. 4, the database 103 is not incorporated, and thus, the database operation section 305 operates the database 103 which is located outside, via the radio-communication section 306. In contrast, in FIG. 7, the database operation section 305 directly operates the database 103 which is incorporated in a controller.

### Second Embodiment

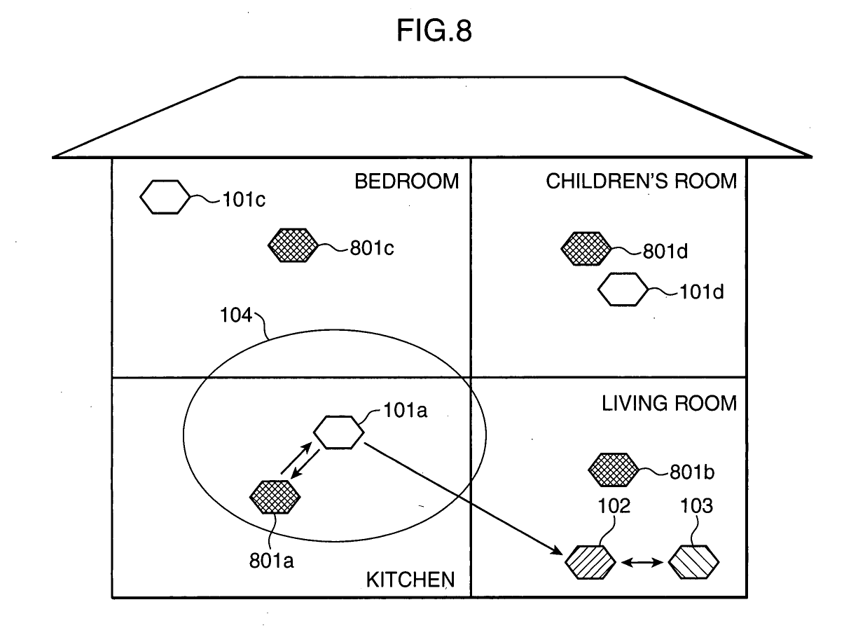

FIG. 8 is an illustration, showing an example of a household-appliance network system according to a second embodiment of the present invention. In FIG. 8, description is omitted about the elements which are common to those of FIG. 1. In FIG. 8, the household-appliance network system according to the second embodiment is configured by: several household electrical appliances 101a, 101c, 101d; a controller (or an equipment control apparatus) 102; a database 103; and reference equipment 801a to 801d. The reference equipment 801a to 801d is equipment which is a reference to information on a position. The reference equipment 801a to 801d is placed, one or more in each place. The reference equipment 801a to 801d is installed when the household-appliance network system is introduced. Besides, desirably, the reference equipment 801a to 801d should be installed at the center of a room.

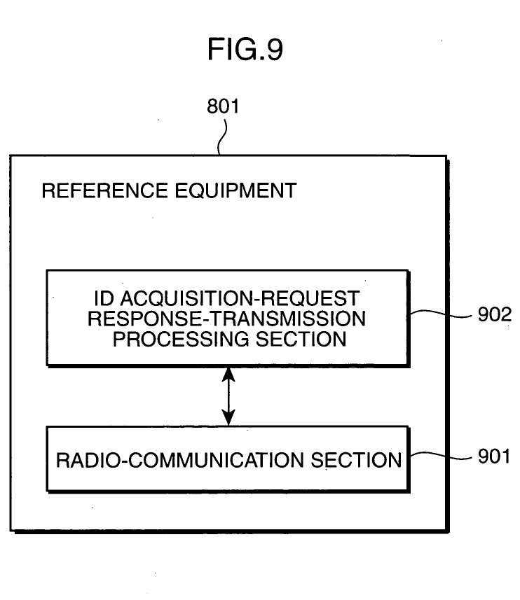

FIG. 9 is a block diagram, showing the function of reference equipment 801 which configures the household-appliance network system according to the present invention. Herein, the reference equipment 801a to 801d has the same configuration, and thus, the reference equipment 801 represents the reference equipment 801a to 801d. In FIG. 9, the reference equipment 801 is made up of a radio-communication section 901 and an ID acquisition-request response-transmission processing section 902.

The radio-communication section 901 is connected to a home-appliance network, so that it can transmit and receive various kinds of data. The ID acquisition-request response-transmission processing section 902 transmits a response packet if it receives an ID acquisition-request packet which has been transmitted by the household electrical appliance 101. Herein, the reference equipment 801 may not be equipment which is dedicated to reference equipment shown in FIG. 9. For example, the household electrical appliance 101 may also work as reference equipment. A home appliance which also functions as reference equipment is usually located at the center of a room, such as lighting fittings. It is desirable that such an appliance be placed in each room.

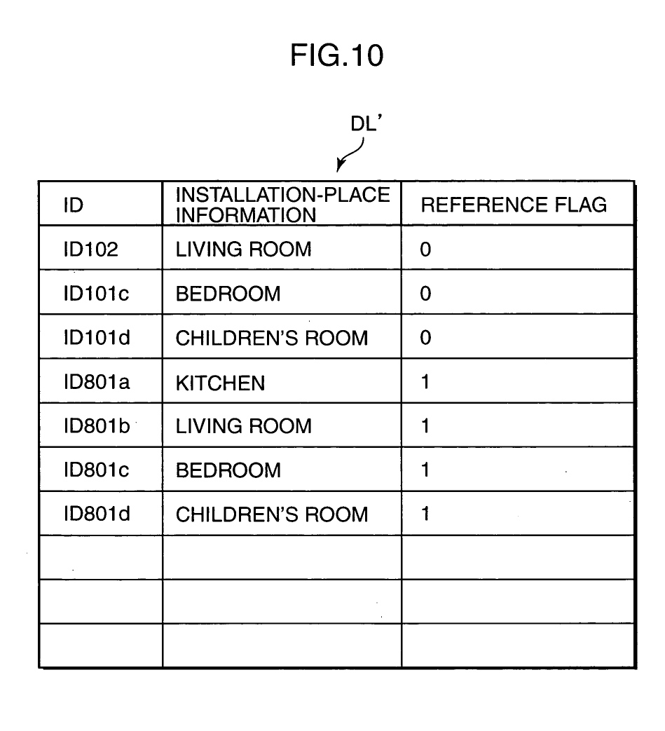

FIG. 10 is a table, showing an example of a data list which is stored in the database 103 according to the second embodiment. In the database 103, a data list DL′ is stored in which ID information on a household electrical appliance is related to installation-place information on the household electrical appliance and reference flag information that shows whether or not it is reference equipment. As shown in FIG. 10, the data list DL′ is made up of the ID information (shown as ID in FIG. 10) on a household electrical appliance, the installation-place information (shown as installation-place information in FIG. 10) on the household electrical appliance and the reference flag information (shown as reference flag in FIG. 10) that shows whether or not it is reference equipment. In the example of FIG. 10, if it is reference equipment, the reference flag is 1, while if it is not reference equipment, the reference flag is 0.

In the household-appliance network system according to the second embodiment, in the same way as that according to the first embodiment, the processing is executed along the flowcharts shown in FIG. 5 and FIG. 6. The second embodiment is different from the first embodiment in how to choose one of the acquired pieces of installation-place information in Step S203. According to the second embodiment, in Step S203, among the IDs of adjoining equipment which are transmitted from a newly-installed household electrical appliance, if one ID of reference equipment is included, or if a plurality of IDs of reference equipment are included and the IDs are translated into the same installation-place information, then the installation-place information which are translated the IDs of reference equipment is chosen. If a plurality of IDs of reference equipment are included and the IDs of reference equipment are translated into different pieces of installation-place information, or if there is no ID of reference equipment, then the pieces of installation-place information are totaled and the largest number of pieces of installation-place information is chosen.

As described above, if the ID acquisition request is broadcasted with the transmission power kept restrained, the household electrical appliances 101c, 101d which are located far away from the newly-installed household electrical appliance 101a will not receive the ID acquisition request. This is because they are within a range where they cannot communicate with it. In contrast, the household electrical appliance 101b which is located near the newly-installed household electrical appliance 101a, is within a range where it can communicate. Thereby, it will receive the ID acquisition request. Then, it sends a reply to the ID to the newly-installed household electrical appliance 101a, and the newly-installed household electrical appliance 101a receives the ID which has been sent by the reply of the adjoining household electrical appliance 101b. In other words, the newly-installed household electrical appliance 101a can selectively acquire an ID of a household electrical appliance which is located near it. Then, the controller 102 receives the ID of the adjoining household electrical appliance which is transmitted by the newly-installed household electrical appliance 101a. This makes it possible to predict the installation place of the newly-installed household electrical appliance 101a.
In addition, the user confirms a candidate of the installation place which is displayed by the controller 102, or the user gives a modification input to it. Thereby, the user can build up a database without becoming aware of an ID which is difficult for the user to recognize.

Besides, the reference equipment 801a to 801d which is a reference to installation-place information, is set in advance. Among the pieces of installation-place information on household electrical appliance which has been retrieved by the database operation section 305, if installation-place information on reference equipment is included, then the installation-place information on reference equipment is projected to be the installation-place information on the newly-installed household electrical appliance 101a. This helps predict the installation place of the household electrical appliance 101a more precisely.

### Third Embodiment

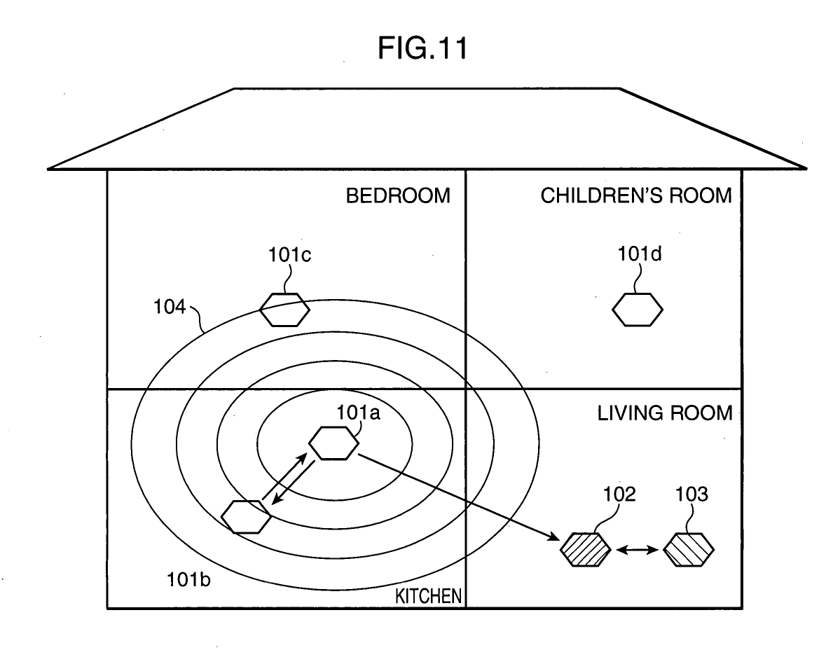

Next, a third embodiment of the present invention will be described. FIG. 11 is an illustration, showing an example of a household-appliance network system according to the third embodiment. In FIG. 11, description is omitted about the elements which are common to those of FIG. 1. In FIG. 11, the household-appliance network system according to the third embodiment is configured by: several household electrical appliances 101a to 101d; a controller (or an equipment control apparatus) 102; and a database 103.

In the first embodiment, the household electrical appliance 101a restrains its transmission power, so that the communicable range can be narrowed. Thereby, the place at which this appliance is installed is predicted. However, in the third embodiment, the household electrical appliance 101a increases (or decreases) the transmission power stepwise. Thereby, the communicable range 104 is gradually enlarged (or narrowed), and thus, the place at which this appliance is installed is predicted.

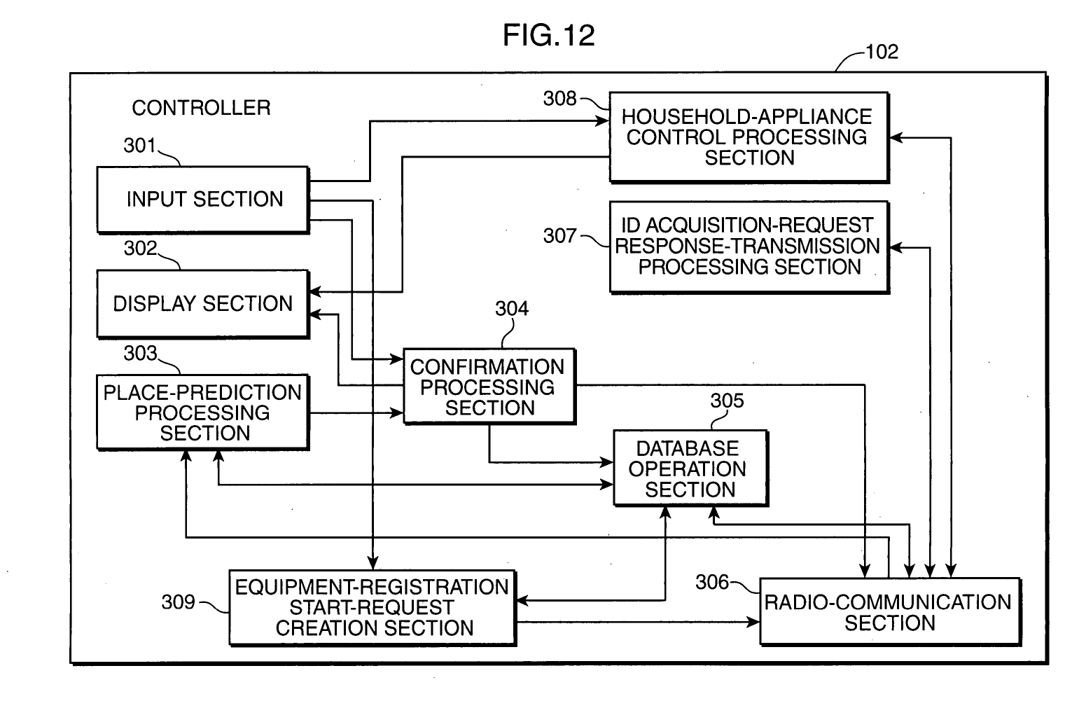

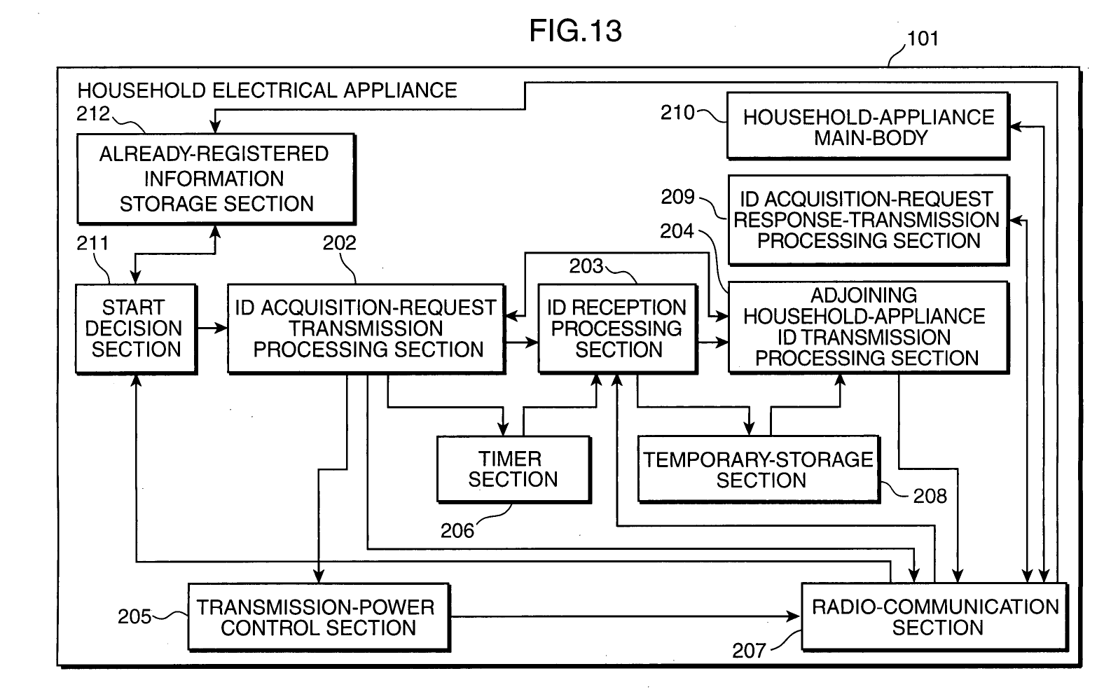

FIG. 12 is a block diagram, showing the function of the controller 102 which configures the household-appliance network system according to the third embodiment. FIG. 13 is a block diagram, showing the function of the household electrical appliance 101 which configures the household-appliance network system according to the third embodiment. Herein, in FIG. 12 and FIG. 13, description is omitted about the elements which are common to those of FIG. 3 and FIG. 4.

In FIG. 12, the controller 102 according to the third embodiment is configured by: an input section 301; a display section 302; a place-prediction processing section 303; a confirmation processing section 304; a database operation section 305; a radio-communication section 306; an ID acquisition-request response-transmission processing section 307; a household-appliance control processing section 308; and an equipment-registration start-request creation section 309.

The input section 301 accepts an input of a registration-start instruction to register a newly-installed home appliance in a database. If the input of a registration-start instruction is accepted by the input section 301, the equipment-registration start-request creation section 309 creates an equipment-registration start request to request a start of an equipment registration for registering the newly-installed home appliance in the database. Specifically, the equipment-registration start-request creation section 309 acquires the number of home appliances which are registered in the database 103. If the number of home appliances is a set number or below, it creates an equipment-registration start request which includes a first power control information for lowering the transmission power stepwise.

The equipment-registration start-request creation section 309 acquires the number of home appliances which are registered in the database 103. If the number of home appliances is above the set number, it creates an equipment-registration start request which includes a second power control information for heightening the transmission power stepwise. Then, the equipment-registration start-request creation section 309 sends the equipment-registration start request to the radio-communication section 306. Sequentially, the radio-communication section 306 transmits, to the household electrical appliance 101, the equipment-registration start request which has been created by the equipment-registration start-request creation section 309.

The confirmation processing section 304 outputs, to the database operation section 305, the installation-place information and the ID of the newly-installed household electrical appliance. In addition, it outputs, to the radio-communication section 306, already-registered information which indicates that the newly-installed household electrical appliance is already registered. Then, the radio-communication section 306 transmits, to the newly-installed household electrical appliance, the already-registered information which has been outputted by the confirmation processing section 304.

In FIG. 13, the household electrical appliance 101 according to the third embodiment is configured by: an ID acquisition-request transmission processing section 202; an ID reception processing section 203; an adjoining household-appliance ID transmission processing section 204; a transmission-power control section 205; a timer section 206; a radio-communication section 207; a temporary-storage section 208; an ID acquisition-request response-transmission processing section 209; a household-appliance main-body 210; a start decision section 211; and an already-registered information storage section 212.

If the already-registered information is received by the radio-communication section 207, the already-registered information storage section 212 stores already-registered information which indicates that the household electrical appliance itself is already registered in the database. Specifically, an already-registered flag is stored in the already-registered information storage section 212. If it is not yet registered, the already-registered flag is set to 0. On the other hand, if it is already registered, the already-registered flag is set to 1.

If the equipment-registration start request is received by the radio-communication section 207, the start decision section 211 refers to the already-registered information storage section 212. Thereby, it confirms whether the household electrical appliance itself is already registered. Then, it decides whether or not a setting-position information registration processing should be started.

If the first power control information is included in the equipment-registration start request which has been received by the radio-communication section 207, the ID acquisition-request transmission processing section 202 instructs the transmission-power control section 205 to execute the first power control for lowering the transmission power stepwise. On the other hand, if the second power control information is included in the equipment-registration start request which has been received by the radio-communication section 207, the ID acquisition-request transmission processing section 202 instructs the transmission-power control section 205 to execute the second power control for heightening the transmission power stepwise.

In addition, if the first power control is in execution and the number of response packets which have been received from another household electrical appliance becomes a set number or below, the ID acquisition-request transmission processing section 202 instructs the transmission-power control section 205 to return the transmission power to the ordinary one. Then, it instructs the adjoining household-appliance ID transmission processing section 204 to transmit the ID to the controller 102.

Furthermore, if the second power control is in execution and the number of response packets which have been received from another household electrical appliance becomes a set number or above, the ID acquisition-request transmission processing section 202 instructs the transmission-power control section 205 to return the transmission power to the ordinary one. Then, it instructs the adjoining household-appliance ID transmission processing section 204 to transmit the ID to the controller 102.

According to this embodiment, the ID acquisition-request transmission processing section 202 corresponds to an example of the acquisition-request transmission section, the transmittable-range setting section and the condition setting section; the equipment-registration start request, to an example of the identification-information acquisition start request; the equipment-registration start-request creation section 309, to an example of the start-request transmission section; the start decision section 211, to an example of the start-request reception section; the already-registered information, to an example of the storage completion information; the confirmation processing section 304, to an example of the confirmation processing section and the storage-completion information transmission section; the already-registered information storage section 212, to an example of the storage-completion information storage section; and the database operation section 305, to an example of the database control section.

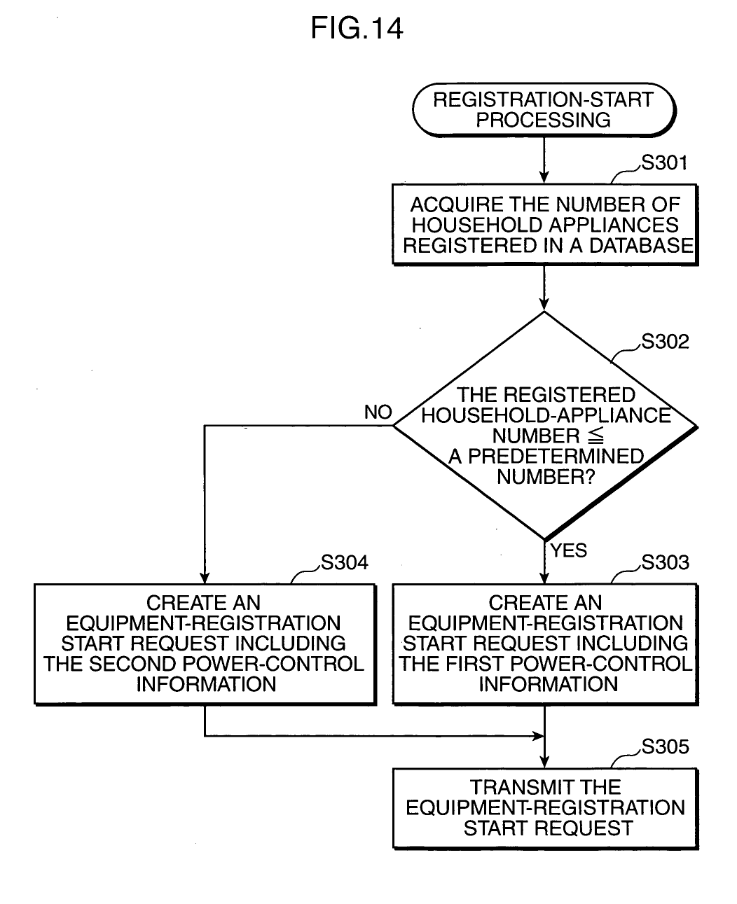

Next, in the case where a home appliance is installed afresh, an installation-information registration processing will be described in the controller 102 according to the third embodiment. Here, the processing of registering the installation information in the database is identical to the processing of the flow chart shown in FIG. 6. Thus, its description is omitted, and a processing performed at the time when the registration is started will be described below. After the processing shown in the flow chart of FIG. 6 is executed (i.e., executing the processing of Step S206), the confirmation processing section 304 of the controller 102 transmits the already-registered information to the newly-installed household electrical appliance 101. The radio-communication section 207 of the household electrical appliance 101 receives the already-registered information transmitted by the controller 102, and writes the received already-registered information into the already-registered information storage section 212. FIG. 14 is a flow chart, showing an example of the registration-start processing which is executed by the controller.

First, the input section 301 of the controller 102 accepts an instruction to start an installation-information registration processing by the user. Then, if the registration-start instruction is accepted by the input section 301, in Step S301, the equipment-registration start-request creation section 309 instructs the database operation section 305 to acquire the number of home appliances which are registered in the database 103. Then, the database operation section 305 accesses the database 103, via the radio-communication section 306. Thereby, it acquires the number of home appliances which are registered at present. Then, the database operation section 305 outputs the number of home appliances to the equipment-registration start-request creation section 309.

Next, in Step S302, the equipment-registration start-request creation section 30.9 decides whether or not the number of registered home appliances which has been outputted by the database operation section 305 is equal to, or less than, a set number which is determined beforehand. Herein, if the decision is made that the number of registered home appliances is equal to, or less than, the set number (YES at Step S302), the processing goes forward to Step S303. On the other hand, if the decision is made that the number of registered home appliances is more than the set number (NO at Step S302), the processing moves ahead to Step S304.

If the decision is made that the number of registered home appliances is a set number or below, in Step S303, the equipment-registration start-request creation section 309 creates an equipment-registration start request which includes a first power control information for lowering the transmission power stepwise.

On the other hand, the decision is made that the number of registered home appliances is more than the set number, in Step S304, the equipment-registration start-request creation section 309 creates an equipment-registration start request which includes a second power control information for heightening the transmission power stepwise.

Next, in Step S305, the equipment-registration start-request creation section 309 outputs, to the radio-communication section 306, the equipment-registration start request which includes the first power control information which has been created in Step S303, or the equipment-registration start request which includes the second power control information which has been created in Step S304. The radio-communication section 306 broadcasts, to all the household electrical appliances 101 which are connected to the controller 102, the equipment-registration start request which has been outputted by the equipment-registration start-request creation section 309.

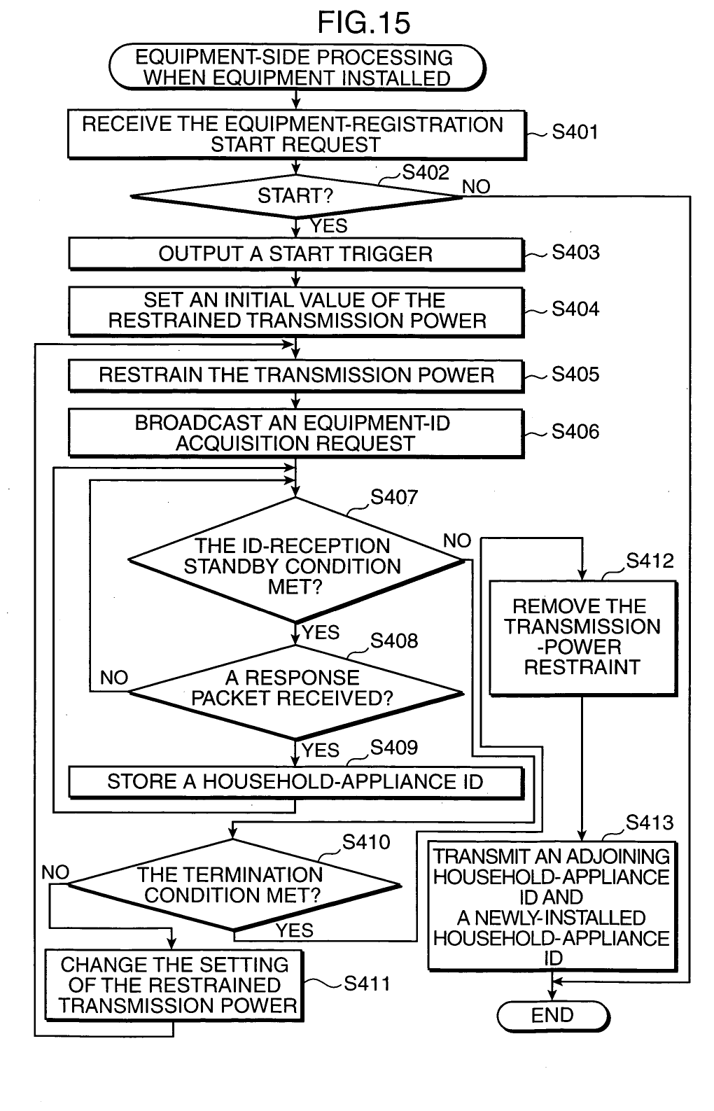

Next, in the case where a home appliance is installed afresh, an installation-information registration processing will be described in the household electrical appliance 101 according to the third embodiment. FIG. 15 is a flow chart, showing an example of an installation-information registration processing which is executed by a newly-installed household electrical appliance.

First, in Step S401, the radio-communication section 207 receives the equipment-registration start request which has been transmitted by the controller 102. Then, the radio-communication section 207 outputs the equipment-registration start request to the start decision section 211.

Next, in Step S402, the start decision section 211 refers to the already-registered information storage section 212. Thereby, it confirms whether the household electrical appliance itself is already registered. Then, it decides whether or not a setting-position information registration processing should be started. If it is not yet registered, the start decision section 211 decides that the setting-position information registration processing should be started. If it is already registered, it decides that the setting-position information registration processing should not be started.

If the decision is made that the setting-position information registration processing should be started (YES at Step S402), in Step S403, a start trigger for starting the setting-position information registration processing is outputted to the ID acquisition-request transmission processing section 202. On the other hand, if the decision is made that the setting-position information registration processing should not be started (NO at Step S402), the setting-position information registration processing is not started, and then, the processing is terminated.

Next, in Step S404, based on the first power control information or the second power control information which is included in the equipment-registration start request, the ID acquisition-request transmission processing section 202 sets an initial value of the transmission power in a restraint state. Herein, if the first power control information is included, the initial value is a transmission-power value at which a transmission distance of substantially five meters can be secured without any obstacle. On the other hand, if the second power control information is included, the initial value is a transmission-power value at which a transmission distance of substantially one meter can be secured without any obstacle.

Next, in Step S405, the transmission-power control section 205 controls the radio-communication section 207, so that the transmission power becomes the initial value which has been set in Step S404. Thereby, it restrains the transmission power.

The processing in Steps S406 to S409 is the same as that of Step S102 and Steps S104 to S106 shown in FIG. 5. Thus, its description is omitted.

In Step S407, if the decision is made that a time-out notification has been received from the timer section 206 (NO at Step S407), the condition for an ID-reception standby is regarded as not having been met. Thus, the processing shifts to Step S410. Next, in Step S410, the adjoining household-appliance ID transmission processing section 204 transmits the number of response packets which have been received from another household electrical appliance from the temporary-storage section 208 to the ID acquisition-request transmission processing section 202. Thereafter, the ID acquisition-request transmission processing section 202 decides whether or not a termination condition has been met. If the decision is made that the termination condition has been met (YES at Step S410), the processing shifts to Step S412. If the decision is made that the termination condition has not been met (NO at Step S410), the processing shifts to Step S411.

Herein, the termination condition is described. The termination condition differs according to the cases in which the first power control is executed and the second power control information is executed. In the case where the first power control is executed, the termination condition is whether or not the number of response packets which have been received from another household electrical appliance is a set number (e.g., five pieces) or below, or whether or not the transmission-power set value is a transmission-power value at which a transmission distance of substantially one meter can be secured without any obstacle. Specifically, if the number of response packets which have been received from another household electrical appliance is a set number (e.g., five pieces) or below, the decision is made that the termination condition has been met. On the other hands, if the number of response packets which have been received from another household electrical appliance is more than a set number (e.g., five pieces), the decision is made that the termination condition has not been met. Or, if the transmission-power set value is a transmission-power value at which a transmission distance of substantially one meter can be secured without any obstacle, the decision is made that the termination condition has been met. On the other hands, if the transmission-power set value is not a transmission-power value at which a transmission distance of substantially one meter can be secured without any obstacle, the decision is made that the termination condition has not been met.

In the case where the second power control is executed, the termination condition is whether or not the number of response packets which have been received from another household electrical appliance is a set number (e.g., five pieces) or above, or whether or not the transmission-power set value is a transmission-power value at which a transmission distance of substantially five meters can be secured without any obstacle. Specifically, if the number of response packets which have been received from another household electrical appliance is a set number (e.g., five pieces) or above, the decision is made that the termination condition has been met. On the other hands, if the number of response packets which have been received from another household electrical appliance is less than a set number (e.g., five pieces), the decision is made that the termination condition has not been met. Or, if the transmission-power set value is a transmission-power value at which a transmission distance of substantially five meters can be secured without any obstacle, the decision is made that the termination condition has been met. On the other hands, if the transmission-power set value is not a transmission-power value at which a transmission distance of substantially five meters can be secured without any obstacle, the decision is made that the termination condition has not been met.

If the decision is made that the termination condition has not been met, in Step S411, the ID acquisition-request transmission processing section 202 changes the setting of the transmission power in restraint. In the case of the first power control, the transmission power is lowered stepwise (e.g., using five levels) from the transmission-power value at which a transmission distance of substantially five meters can be secured without any obstacle. In this embodiment, the transmission distance is shortened by one meter for each step. Therefore, if the transmittable distance is set at the transmission power which is equivalent to a distance of substantially five meters, the setting of the transmission power is changed to a transmittable distance of substantially four meters. Similarly, In the case of the second power control, the transmission power is heightened stepwise (e.g., using five levels) from the transmission-power value at which a transmission distance of substantially one meter can be secured without any obstacle. In this embodiment, the transmission power increases stepwise so that the transmission distance becomes longer by one meter. Therefore, if the transmittable distance is set at the transmission power which is equivalent to a distance of substantially one meter, the setting of the transmission power is changed to a transmittable distance of substantially two meters. Then, after the setting of the transmission power has been changed, the processing returns to Step S405. Afterward, the processing of Steps S405 to S410 is repeated.

On the other hand, if the decision is made that the termination condition has been met, in Step S412, the ID acquisition-request transmission processing section 202 returns, to an ordinary transmission power, the transmission power of the radio-communication section 207 which has been restrained by the transmission-power control section 205.

Next, in Step S413, the adjoining household-appliance ID transmission processing section 204 the ID of an adjoining household electrical appliance from the temporary-storage section 208. Then, it transmits it, together with the ID of the newly-installed household electrical appliance itself, through the radio-communication section 207 to the controller 102. If there is no already-installed household electrical appliance around it, or if the ID of an adjoining household electrical appliance is not stored in the temporary-storage section 208, the adjoining household-appliance ID transmission processing section 204 notifies it of the ID of the newly-installed household electrical appliance itself and that there is no response to the ID acquisition request.

In this way, the transmittable range where the identification-information acquisition request can be transmitted broadcast is set to narrow stepwise. On the other hand, if a large number of pieces of electrical equipment are already stored in the database, the transmittable range where the identification-information acquisition request can be transmitted broadcast is set to widen stepwise. Then, whether or not the number of the received pieces of identification information has reached a predetermined number that is decided in advance is set as a condition. If the number of the received pieces of identification information has reached a predetermined number that is decided in advance, the identification information on another household electrical appliance is transmitted to the controller 102.

Hence, the transmittable range is set to narrow stepwise, and thus, the identification information on another household electrical appliance can be obtained which is installed in a position closer to the newly-installed household electrical appliance 101a. This helps predict the installation place of the newly-installed household electrical appliance 101a more precisely. Besides, if the number of the received pieces of identification information has reached the predetermined number that is decided in advance, the identification information on another household electrical appliance is transmitted to the controller 102. Thereby, in the case where there are especially only a small number of other already-installed household electrical appliances, the time of processing can be shortened which will be taken to obtain identification information on other household electrical appliances.

In contrast, the transmittable range where the identification-information acquisition request can be transmitted broadcast is set to widen stepwise. On the other hand, if a large number of pieces of electrical equipment are already stored in the database, the transmittable range where the identification-information acquisition request can be transmitted broadcast is set to widen stepwise. Then, whether or not the number of the received pieces of identification information has reached a predetermined number that is decided in advance is set as a condition. If the number of the received pieces of identification information has reached a predetermined number that is decided in advance, the identification information on another household electrical appliance is transmitted to the controller 102.

Hence, the transmittable range is set to widen stepwise from the narrow range, and thus, the identification information on another household electrical appliance can be obtained which is installed in a position closer to the newly-installed household electrical appliance 101a. This helps predict the installation place of the newly-installed household electrical appliance 101a more precisely. Besides, if the number of the received pieces of identification information has reached the predetermined number that is decided in advance, the identification information on another household electrical appliance is transmitted to the controller 102. Thereby, in the case where there are especially a large number of other already-installed household electrical appliances, the time of processing can be shortened which will be taken to obtain identification information on other household electrical appliances.

In addition, if an identification-information acquisition start request is transmitted to start to acquire the identification information on another household electrical appliance is received, the identification-information acquisition request to acquire the identification information on another household electrical appliance is transmitted broadcast. Therefore, if the household electrical appliance 101a receives the identification-information acquisition start request, it can automatically transmit broadcast the identification-information acquisition request.

Furthermore, if a small number of pieces of equipment information are already stored in the database 103, the transmittable range where the identification-information acquisition request can be transmitted broadcast is set to narrow stepwise. On the other hand, if a large number of pieces of equipment information are already stored in the database 103, the transmittable range where the identification-information acquisition request can be transmitted broadcast is set to widen stepwise. Thereby, the time of processing which will be taken to obtain identification information on other household electrical appliances can be shortened according to the number of other household electrical appliances which are already installed.

Moreover, whether the displayed installation-place information is correct is confirmed. If the confirmation is obtained that the installation-place information on the household electrical appliance 101a is correct, the installation-place information is stored in the database 103. Then, storage completion information which indicates that the storage of the installation-place information in the database 103 is completed, is transmitted to the household electrical appliance 101a. Next, in the household electrical appliance 101a, the transmitted storage completion information is received, and then, the received storage completion information is stored. Thereafter, if the identification-information acquisition start request is received, the storage completion information is referred to. If the storage completion information is not stored, the identification-information acquisition request is transmitted broadcast. On the other hand, if the storage completion information is referred to and the storage completion information is stored, the identification-information acquisition request is not transmitted broadcast.

Therefore, even if the household electrical appliance receives the identification-information acquisition request, the identification-information acquisition request is not transmitted broadcast, as long as the storage completion information is stored. Therefore, only the newly-installed household electrical appliance which receives the identification-information acquisition start request can transmit broadcast the identification-information acquisition request.

Herein, according to the third embodiment, the information which indicates whether the first power control should be executed or the second power control should be executed, is included in the equipment-registration start request which is transmitted by the controller 102. Then, both of them are transmitted, so that the transmission power is changed in the household electrical appliance 101. However, the present invention is not limited especially to this. As can be seen in the first embodiment, in the case where the household electrical appliance 101 includes the input section 201, the input section 201 may also accept a choice whether the first power control should be executed, or the second power control should be executed. Besides, the household electrical appliance 101 may also execute only either of the first power control and the second power control.

Furthermore, according to the third embodiment, the transmission power is restrained to a predetermined power. Thereafter, the transmission power is gradually raised or reduced, and then, the ID acquisition request is transmitted. However, the present invention is not limited especially to this. After it is restrained to a predetermined power, the ID acquisition request may also be transmitted. In that case, response packets to the ID acquisition request are received. Then, according to the number of the received response packets, a choice is made whether the transmission power is gradually raised or reduced.

For example, first, the transmission power is restrained to the power at which a transmission distance of three meters can be secured with no obstacle. Thereafter, the ID acquisition request is transmitted. Then, if the number of received response packets is a first set number (e.g., seven pieces) or above, the first power control is executed which lowers the transmission power stepwise. If the number of received response packets is below a second set number (e.g., four pieces) which is less than the first set number, the second power control is executed which heightens the transmission power stepwise. In this case, the termination condition for the ID acquisition is whether or not the number of received response packets has become the second set number or above, and below the first set number (e.g., four to six pieces), or whether or not the transmittable distance of the transmission power has become five meters or one meter.

In this way, the transmission power is restrained to a predetermined power, and thereafter, the ID acquisition request is transmitted. Then, response packets to the ID acquisition request are received, and according to the number of the received response packets, a choice is made whether the transmission power is gradually raised or reduced. Thereby, after it is restrained to a predetermined transmission power, the transmission power is gradually raised or reduced and the ID acquisition request is transmitted. Thus, the ID of another household electrical appliance can be acquired before the response packets are received.

In addition, the second embodiment and the third embodiment may also be combined. In the second embodiment, the information that shows whether or not it is reference equipment is stored in the database 103. However, reference equipment may also store the information on whether or not it is reference equipment. In that case, in a response packet to the ID acquisition request, the information which shows that it is reference equipment is included and transmitted. Then, in the case where the first power control is executed, the termination condition for the ID acquisition is whether or not the number of the acquired reference-equipment IDs has become one or below. On the other hand, in the case where the second power control is executed, the termination condition for the ID acquisition is whether or not the number of the acquired reference-equipment IDs has become one or above.

### Fourth Embodiment

Next, a fourth embodiment of the present invention will be described. In the first embodiment, the place-prediction processing section 303 of the controller 102 predicts, as the installation place of a newly-installed household electrical appliance, the largest number of pieces of installation-place information which correspond to the received IDs. In contrast, in the fourth embodiment, layout information is stored beforehand which relates each installation place to a transmittable distance. Base on the installation-place information which corresponds to the received ID and the layout information, the place-prediction processing section 303 predicts the installation place in which the household electrical appliance is probably installed.

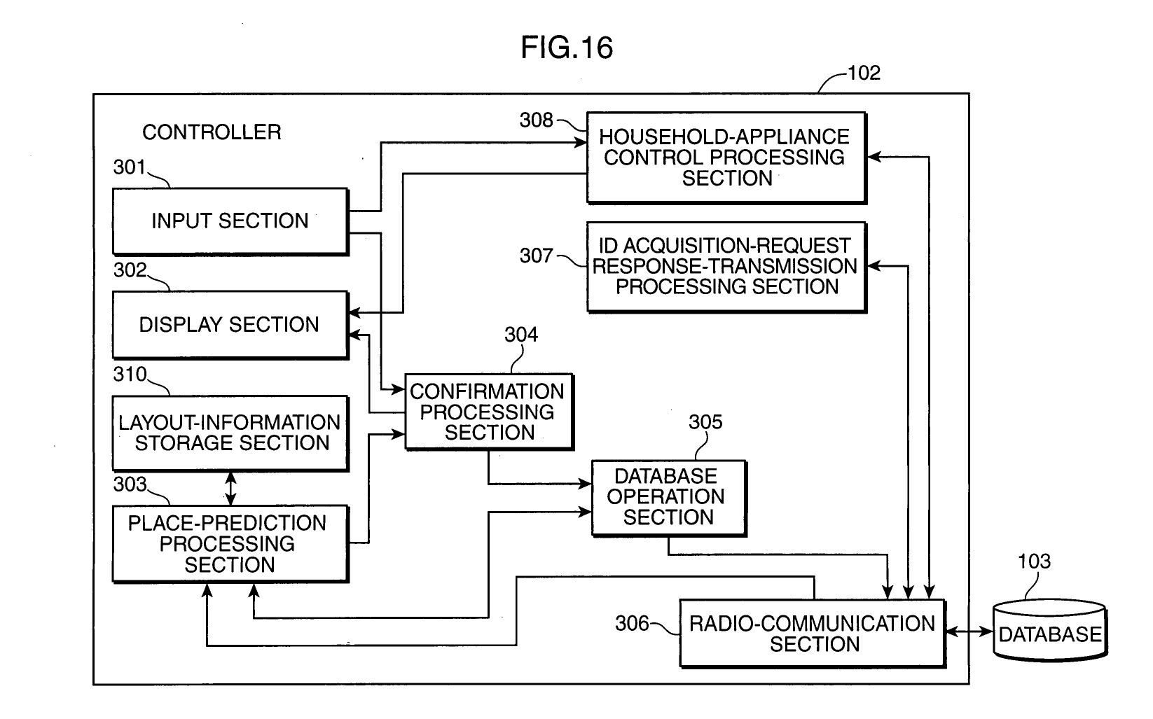

FIG. 16 is a block diagram, showing the function of the controller 102 which configures a household-appliance network system according to the fourth embodiment of the present invention. In FIG. 16, the controller 102 is configured by a layout-information storage section 310, in addition to the configuration of the controller 102 according to the first embodiment shown in FIG. 4.

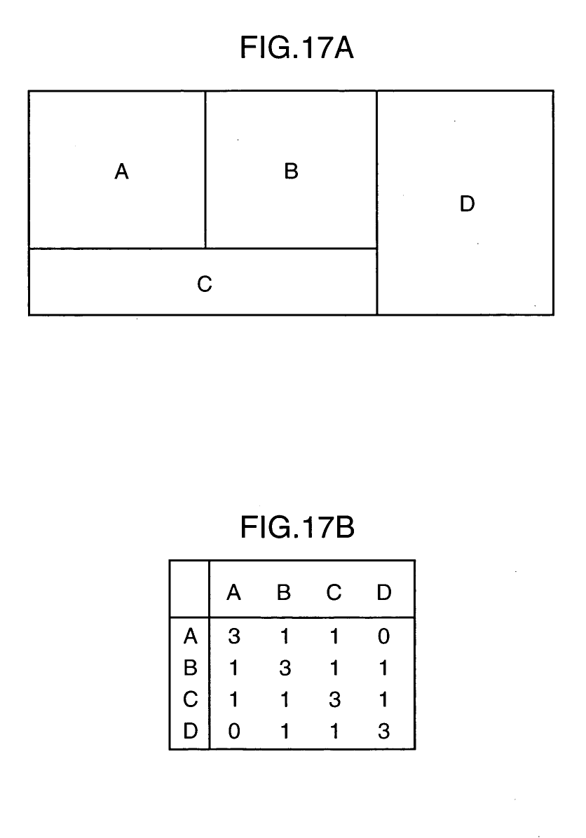

The layout-information storage section 310 stores in advance layout information which relates each installation place to a transmittable distance. FIGS. 17A and 17B are representations, showing the layout information according to the fourth embodiment. FIG. 17A shows an example of the layout of rooms in a house, seen from above. FIG. 17B shows an example of the layout information. Installation places A, B, C, D shown in FIG. 17A each show a room such as a living room, a kitchen and a bedroom, a passageway, or the like. As shown in FIG. 17B, the layout information is data in a table where a numeric value that corresponds to a transmittable distance is related to each installation place.

For example, in the line of the installation place A in FIG. 17B, the element in the row of a place closer to the installation place A has a larger numeric value. In the line of the installation place A, the element in the row of the installation place A is “3,”. The element in the row of each installation place B, C which is adjacent to the installation place A is “1”. The element in the row of the installation place D which is not adjacent to the installation place A is “0”. Herein, the above described “3”, “1” or “0” is only an example of such a numeric value. The more easily the place is reached by a radio wave, the greater numeric value is given. For example, if the installation place A and the installation place B are partitioned by a wall which cannot transmit a radio wave, the element in the row of the installation place B is “0”, even though the installation place A is adjacent to the installation place B.

Hence, layout information in a matrix format is stored beforehand which relates a plurality of installation places to a numeric value that corresponds to a transmittable distance to each other. Then, the elements are added which correspond to the lines of each of a plurality of retrieved pieces of installation-place information. Next, the installation-place information is predicted according to the numeric value of the added elements. Therefore, the installation-place information on the electrical equipment can be more precisely predicted.

Next, an installation-place prediction processing by the place-prediction processing section 303 according to the fourth embodiment will be described. The IDs of five household electrical appliances are received by the radio-communication section 306. Then, they are retrieved by the database operation section 305. Let's assume the installation place which corresponds to the ID of each household electrical appliance to be A, B, B, C, D. In this case, the place-prediction processing section 303 adds the element which corresponds to the line of each installation place A, B, B, C, D. Specifically, if the line A, the line B, the line B, the line C and the line D are added up, (3,1,1,0)+(1,3,1,1)+(1,3,1,1)+(1,1,3,1)+(0,1,1,3)=(6,9,7,6). The place-prediction processing section 303 predicts that among the numeric values which are obtained by the calculation, the greater numeric value the element has, the more probably it will be the installation place. In this example, the order of more probable installation places is the installation place B, the installation place C, the installation place A, the installation place D.

Then, the place-prediction processing section 303 places the acquired pieces of installation-place information in the order of high probability. Then, it transmits, to the confirmation processing section 304, the pieces of installation-place information whose order has been given. The confirmation processing section 304 receives the pieces of installation-place information which have been transmitted by the place-prediction processing section 303. Then, it displays, in the display section 302, the pieces of installation-place information in the order of high probability.

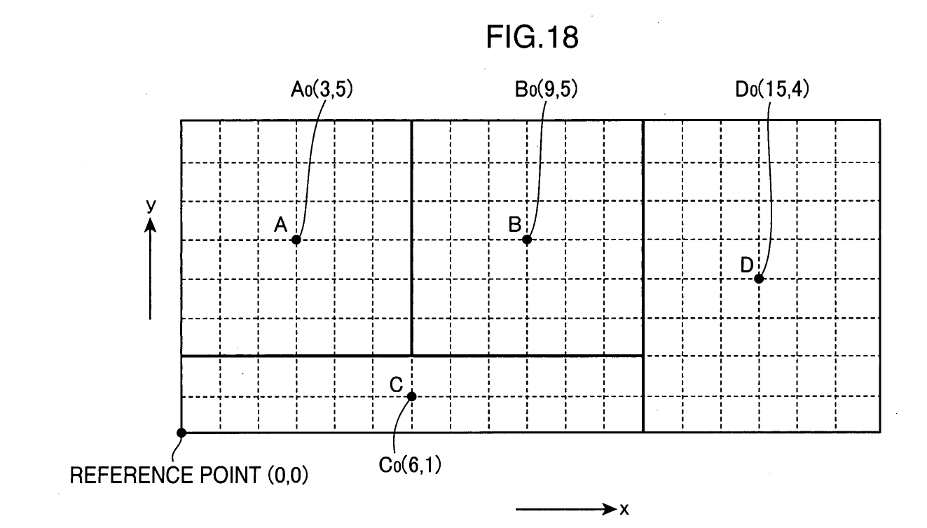

Next, a variation of the fourth embodiment will be described. In the above described fourth embodiment, the layout-information storage section 310 stores a numeric value that corresponds to a transmittable distance, so that it is related to each installation place. In contrast, the layout-information storage section 310 according to the variation of the fourth embodiment stores the central coordinates of each installation place. FIG. 18 is a representation, showing layout information according to the variation of the fourth embodiment. As shown in FIG. 18, if a lower-left edge part is a reference point (or the origin of coordinate axes) when a house is seen from above, the central coordinates Ao, Bo, Co, Do of each installation place A, B, C, D are (3, 5), (9, 5), (6, 1), (15, 4), respectively. Herein, the right direction of this figure is x-axis, and the upper direction of this figure is y-axis.

Next, an installation-place prediction processing by the place-prediction processing section 303 according to the variation of the fourth embodiment will be described. The IDs of five household electrical appliances are received by the radio-communication section 306. Then, they are retrieved by the database operation section 305. Let's assume the installation place which corresponds to the ID of each household electrical appliance to be A, B, B, C, D. In this case, the place-prediction processing section 303 calculates the central coordinates Ao, Bo, Bo, Co, Do of each installation place A, B, B, C, D. Specifically, the average coordinates of the central coordinates Ao, Bo, Bo, Co, Do are {(3, 5)+(9, 5)+(9, 5)+(6, 1)+(15, 4)}/5=(8.4, 4).

Then, the place-prediction processing section 303 calculates the square of the distance between the average coordinates and each set of the central coordinates. Specifically, the square of the distance between the average coordinates (8.4, 4) and the central coordinates Ao (3, 5) of the installation place A is {(3, 5)−(8.4, 4)}²=(−5.4, 1)²=30.16. Then, the square of the distance between the average coordinates (8.4, 4) and the central coordinates Bo (9, 5) of the installation place B is {(9, 5)−(8.4, 4)}²=(0.6, 1)²=1.36. Next, the square of the distance between the average coordinates (8.4, 4) and the central coordinates Co (6, 1) of the installation place C is {(6, 1)−(8.4, 4)}²=(−2.4, −3)²=14.76. In the same way, the square of the distance between the average coordinates (8.4, 4) and the central coordinates Do (15, 4) of the installation place D is {(15, 4)−(8.4, 4)}²=(6.6, 0)²=43.56.

Then, the place-prediction processing section 303 predicts that among the values of the square of the distance which have been obtained by the calculation, the lower value the installation place has, the more probably it will be the installation place. In this example, the order of more probable installation places is the installation place B, the installation place C, the installation place A, the installation place D. Then, the place-prediction processing section 303 places the acquired pieces of installation-place information in the order of high probability. Then, it transmits, to the confirmation processing section 304, the pieces of installation-place information whose order has been given. The confirmation processing section 304 receives the pieces of installation-place information which have been transmitted by the place-prediction processing section 303. Then, it displays, in the display section 302, the pieces of installation-place information in the order of high probability.

Herein, in this variation, the distance may also be calculated between the average coordinates and each set of the central coordinates. In that case, a square root needs to be calculated, thus making the processings lower. Therefore, in this variation, the square of the distance between the average coordinates and each set of the central coordinates is calculated, so that the calculation quantity becomes smaller. Besides, in this variation, the layout information is expressed using the two-dimensional coordinates. However, if a two-storied house or the like is taken into account, it may also be expressed using the three-dimensional coordinates.

As described above, layout information that relates a plurality of installation places to a relative position to each other is stored in advance. Based on the retrieved installation-place information and the stored layout information, a plurality of pieces of information on installation places are predicted in which the newly-installed household electrical appliance 101a is probably installed. Then, the predicted pieces of installation-place information are displayed in order of the probability that the newly-installed household electrical appliance 101a is installed. This allows the user to confirm the installation place easily.

In addition, layout information which indicates the central coordinates of each of a plurality of installation places is stored in advance. Then, the average coordinates of a plurality of retrieved pieces of installation-place information are calculated. Next, the distance between the average coordinates and the central coordinates of each installation place is calculated. Sequentially, the installation-place information is predicted according to the calculated distance. Therefore, the installation-place information on the electrical equipment can be more precisely predicted.

As described above, the equipment control apparatus comprises: a communication section which receives, from first electrical equipment, identification information on second electrical equipment that is located within a predetermined range from the first electrical equipment, a database control section which retrieves, from a database in which installation-place information that indicates an installation place of electrical equipment is stored so as to correspond to identification information on electrical equipment, the installation-place information which corresponds to the identification information on the second electrical equipment which is received by the communication section, a place-prediction processing section which predicts installation-place information on the first electrical equipment, based on the identification information on the second electrical equipment which is received by the communication section and the installation-place information which is retrieved by the database control section, and a display section which displays the installation-place information that is predicted by the place-prediction processing section.

According to this configuration, identification information on the second electrical equipment that is located within a predetermined range from the first electrical equipment is received from the first electrical equipment. Then, from a database in which installation-place information that indicates an installation place of electrical equipment is stored so as to correspond to the identification information on the electrical equipment, the installation-place information which corresponds to the identification information on the second electrical equipment, is retrieved. Sequentially, installation-place information on the first electrical equipment is predicted based on the identification information on the second electrical equipment and the retrieved installation-place information. Then, the predicted installation-place information is displayed.

Therefore, an installation place of electrical equipment which is newly installed is predicted based upon identification information on the electrical equipment near the newly-installed electrical equipment. Then, a candidate for the predicted installation place is displayed. Thereby, there is no need for the user to become aware of identification information on electrical equipment to be installed. In other words, all the user has to do is to confirm its installation place. In such a way, the disposition place of the newly-installed electrical equipment can be registered in a database.

Furthermore, in the above described equipment control apparatus, preferably, the place-prediction processing section should predict that among the pieces of installation-place information on the second electrical equipment which are retrieved by the database control section, the largest number of pieces of installation-place information will be the installation-place information on the first electrical equipment.

According to this configuration, among the retrieved pieces of installation-place information on the second electrical equipment, the largest number of pieces of installation-place information are expected to be the installation-place information on the first electrical equipment. In other words, the greater the number of pieces of installation-place information becomes, the more likely the installation place becomes the same as the first electrical equipment. Therefore, among the retrieved installation places of the second electrical equipment, the most installation places are projected to be the installation place of the first electrical equipment.

Moreover, in the above described equipment control apparatus, it is preferable that reference equipment whose installation place is specified in advance be predetermined; and if installation-place information on the reference equipment is included among the pieces of installation-place information on the second electrical equipment which are retrieved by the database control section, the place-prediction processing section predict that the installation-place information on the reference equipment will be the installation-place information on the first electrical equipment.

According to this configuration, reference equipment whose installation place is specified in advance is predetermined. If installation-place information on the reference equipment is included among the retrieved pieces of installation-place information on the second electrical equipment, the place-prediction processing section predict that the installation-place information on the reference equipment will be the installation-place information on the first electrical equipment. Therefore, the installation place of the first electrical equipment can be more precisely predicted.

In addition, in the above described equipment control apparatus, preferably, the equipment control apparatus may further comprise an input section which accepts a confirmation input by a user of the installation-place information that is displayed by the display section, and a confirmation processing section which confirms, using the input section, whether the installation-place information that is predicted by the place-prediction processing section is correct; and if the confirmation processing section confirms that the installation-place information on the first electrical equipment is correct, the database control section should store the installation-place information in the database.

According to this configuration, the user confirms whether the displayed installation-place information is correct. Then, if the confirmation is obtained that the installation-place information on the first electrical equipment is correct, the installation-place information is stored in the database. Hence, the user confirms the installation place, thus making it possible to store such an accurate installation place in a database.

Furthermore, in the above described equipment control apparatus, it may be preferable that the equipment control apparatus further comprise a layout-information storage section which stores, in advance, layout information that relates a plurality of installation places to a relative position to each other; based on the installation-place information which is retrieved by the database control section and the layout information which is stored in the layout-information storage section, the place-prediction processing section predict a plurality of pieces of information on installation places in which the first electrical equipment is probably installed; and the display section display the pieces of installation-place information which are predicted by the place-prediction processing section in order of the probability that the first electrical equipment is installed.

According to this configuration, layout information that relates a plurality of installation places to a relative position to each other is stored in advance. Based on the retrieved installation-place information and the stored layout information, a plurality of pieces of information on installation places are predicted in which the first electrical equipment is probably installed. Then, the predicted pieces of installation-place information are displayed in order of the probability that the first electrical equipment is installed. This allows the user to confirm the installation place easily.

Moreover, in the above described equipment control apparatus, preferably, the layout-information storage section may store, in advance, layout information in a matrix format which relates a plurality of installation places to a numeric value that corresponds to a transmittable distance to each other; and the place-prediction processing section should add the elements which correspond to the lines of each of a plurality of pieces of installation-place information which are retrieved by the database control section, and should predict the installation-place information according to the numeric value of the added elements.

According to this configuration, layout information in a matrix format is stored beforehand which relates a plurality of installation places to a numeric value that corresponds to a transmittable distance to each other. Then, the elements are added which correspond to the lines of each of a plurality of retrieved pieces of installation-place information. Next, the installation-place information is predicted according to the numeric value of the added elements. Therefore, the installation-place information on the first electrical equipment can be more precisely predicted.

In addition, in the above described equipment control apparatus, it may be preferable that the layout-information storage section store, in advance, layout information which indicates the central coordinates of each of a plurality of installation places; and the place-prediction processing section calculate the average coordinates of a plurality of pieces of installation-place information which are retrieved by the database control section, calculate the distance between the average coordinates and the central coordinates of each installation place, and predict the installation-place information according to the calculated distance.

According to this configuration, layout information which indicates the central coordinates of each of a plurality of installation places is stored in advance. Then, the average coordinates of a plurality of retrieved pieces of installation-place information are calculated. Next, the distance between the average coordinates and the central coordinates of each installation place is calculated. Sequentially, the installation-place information is predicted according to the calculated distance. Therefore, the installation-place information on the first electrical equipment can be more precisely predicted.

Furthermore, in the above described equipment control apparatus, it may be preferable that the equipment control apparatus further comprise, an input section which accepts a confirmation input by a user of the installation-place information that is displayed by the display section, and a confirmation processing section which confirms, using the input section, whether the installation-place information that is predicted by the place-prediction processing section is correct; if the confirmation processing section confirms that the installation-place information on the first electrical equipment is correct, the database control section stores the installation-place information in the database. The equipment control apparatus may further comprise a storage-completion information transmission section which transmits, to the first electrical equipment, storage completion information which indicates that the storage of the installation-place information in the database is completed by the database control section.

According to this configuration, in the equipment control apparatus, the user confirms whether the displayed installation-place information is correct. If the confirmation is obtained that the installation-place information on the electrical equipment is correct, the installation-place information is stored in the database. Then, storage completion information which indicates that the storage of the installation-place information in the database is completed, is transmitted to the electrical equipment. Thus, the equipment control apparatus can notify the electrical equipment that the storage of the installation-place information in the database is completed.

Moreover, in the above described equipment control apparatus, it may be preferable that the equipment control apparatus further comprise, a start-request transmission section which transmits, to the first electrical equipment, an identification-information acquisition start request to start to acquire the identification information on the second electrical equipment, and a creation section which creates the identification-information acquisition start request that includes a first setting information for narrowing stepwise a transmittable range where the identification-information acquisition request to acquire the identification information on the second electrical equipment is transmitted broadcast if the number of pieces of electrical equipment which are stored in the database is a predetermined number or below, and a second setting information for widening stepwise the transmittable range where the identification-information acquisition request is transmitted broadcast if the number of the pieces of electrical equipment which are stored in the database is the predetermined number or above.

According to this configuration, in the equipment control apparatus, the identification-information acquisition start request is created which includes a first setting information for narrowing stepwise a transmittable range where the identification-information acquisition request to acquire the identification information on the second electrical equipment can be transmitted broadcast if the number of pieces of electrical equipment which are stored in the database is a predetermined number or below, and a second setting information for widening stepwise the transmittable range where the identification-information acquisition request can be transmitted broadcast if the number of the pieces of electrical equipment which are stored in the database is the predetermined number or above. Then, the created identification-information acquisition start request is transmitted to the first electrical equipment. Thus, the setting information for changing the transmittable range based on the number of the electrical equipment which has already been installed can be transmitted to the electrical equipment.

The electrical equipment, which is communicably connected to an equipment control apparatus that controls the electrical equipment, comprises: an acquisition-request transmission section which transmits broadcast an identification-information acquisition request to acquire identification information on another piece of electrical equipment, an identification-information reception section which, in response to the identification-information acquisition request that is transmitted by the acquisition-request transmission section, receives identification information on another piece of electrical equipment within a predetermined range, and an identification-information transmission section which transmits, to the equipment control apparatus, the identification information on another piece of electrical equipment that is received by the identification-information reception section.

According to this configuration, an identification-information acquisition request to acquire identification information on another piece of electrical equipment, is transmitted broadcast. In response to the transmitted identification-information acquisition request, identification information on another piece of electrical equipment within a predetermined range, is received. Then, the received identification information on another piece of electrical equipment is transmitted to the equipment control apparatus.

Therefore, identification information on another piece of electrical equipment near the newly-installed electrical equipment can be acquired. Then, this identification information is transmitted to the equipment control apparatus. Thereby, the installation place of the newly-installed electrical equipment can be predicted.

Furthermore, in the above described electrical equipment, preferably, the electrical equipment may further include a transmittable-range setting section which sets stepwise a transmittable range where the identification-information acquisition request is transmitted broadcast, and a condition setting section which sets a condition for receiving identification information from another piece of electrical equipment; the transmittable-range setting section should narrow the transmittable range stepwise; the condition setting section should set, as a condition, whether or not the number of the pieces of identification information which are received by the identification-information reception section reaches a predetermined number that is decided in advance; and if the number of the pieces of identification information which are received by the identification-information reception section reaches the predetermined number that is decided in advance, the identification-information transmission section should transmit the identification information on another piece of electrical equipment to the equipment control apparatus.

According to this configuration, a transmittable range is set to narrow stepwise in which the identification-information acquisition request can be transmitted broadcast. Then, whether or not the number of the received pieces of identification information has reached a predetermined number that is decided in advance is set as a condition. If the number of the received pieces of identification information has reached the predetermined number that is decided in advance, the identification information on another piece of electrical equipment is transmitted to the equipment control apparatus.

Hence, the transmittable range is set to narrow stepwise, and thus, the identification information on another piece of electrical equipment can be obtained which is installed in a position closer to electrical equipment that is newly installed. This helps predict the installation place of the newly-installed electrical equipment more precisely. Besides, if the number of the received pieces of identification information has reached the predetermined number that is decided in advance, the identification information on another piece of electrical equipment is transmitted to the equipment control apparatus. Thereby, in the case where there are especially only a small number of other pieces of electrical equipment, the time of processing can be shortened which will be taken to obtain identification information on other pieces of electrical equipment.

Moreover, in the above described electrical equipment, it may be preferable that the electrical equipment further comprise, a transmittable-range setting section which sets stepwise a transmittable range where the identification-information acquisition request is transmitted broadcast, and a condition setting section which sets a condition for receiving identification information from another piece of electrical equipment; the transmittable-range setting section widen the transmittable range stepwise; the condition setting section set, as a condition, whether or not the number of the pieces of identification information which are received by the identification-information reception section reaches a predetermined number that is decided in advance; and if the number of the pieces of identification information which are received by the identification-information reception section reaches the predetermined number that is decided in advance, the identification-information transmission section transmit the identification information on another piece of electrical equipment to the equipment control apparatus.

According to this configuration, a transmittable range is set to widen stepwise in which the identification-information acquisition request can be transmitted broadcast. Then, whether or not the number of the received pieces of identification information has reached a predetermined number that is decided in advance is set as a condition. If the number of the received pieces of identification information has reached the predetermined number that is decided in advance, the identification information on another piece of electrical equipment is transmitted to the equipment control apparatus.

Hence, the transmittable range is set to widen stepwise from a narrow range, and thus, the identification information on another piece of electrical equipment can be obtained which is installed in a position closer to electrical equipment that is newly installed. This helps predict the installation place of the newly-installed electrical equipment more precisely. Besides, if the number of the received pieces of identification information has reached the predetermined number that is decided in advance, the identification information on another piece of electrical equipment is transmitted to the equipment control apparatus. Thereby, in the case where there are especially a large number of other pieces of electrical equipment, the time of processing can be shortened which will be taken to obtain identification information on other pieces of electrical equipment.

In addition, in the above described electrical equipment, preferably, the equipment control apparatus may transmit an identification-information acquisition start request to start to acquire the identification information on another piece of electrical equipment. The electrical equipment may further comprise a start-request reception section which receives the identification-information acquisition start request that is transmitted by the equipment control apparatus; and if the identification-information acquisition start request is received by the start-request reception section, the acquisition-request transmission section transmit broadcast the identification-information acquisition request to acquire the identification information on another piece of electrical equipment.

According to this configuration, in the equipment control apparatus, an identification-information acquisition start request is transmitted to start to acquire the identification information on another piece of electrical equipment. Then, in the electrical equipment, if the identification-information acquisition start request transmitted by the equipment control apparatus is received, the identification-information acquisition request to acquire the identification information on another piece of electrical equipment is transmitted broadcast. Therefore, if the electrical equipment receives the identification-information acquisition start request which has been transmitted by the equipment control apparatus, it can automatically transmit broadcast the identification-information acquisition request.

Furthermore, in the above described electrical equipment, it may be preferable that the electrical equipment further comprise, a storage-completion information storage section which stores the storage completion information which indicates that the storage of the installation-place information in the database is completed by the equipment control apparatus; and if the identification-information acquisition start request is received by the start-request reception section, the acquisition-request transmission section refers to the storage-completion information storage section, and if the storage completion information is not stored, it transmits broadcast the identification-information acquisition request to acquire the identification information on another piece of electrical equipment.

According to this configuration, in the equipment control apparatus, storage completion information which indicates that the storage of the installation-place information in the database is completed, is stored in the storage-completion information storage section. Thereafter, if the identification-information acquisition start request is received, the storage-completion information storage section is referred to. If the storage completion information is not stored, the identification-information acquisition request to acquire the identification information on another piece of electrical equipment is transmitted broadcast. On the other hand, if the storage-completion information storage section is referred to and the storage completion information is stored, the identification-information acquisition request to acquire the identification information on another piece of electrical equipment is not transmitted broadcast.

In this way, even if the electrical equipment receives the identification-information acquisition request, the identification-information acquisition request is not transmitted broadcast, as long as the storage completion information is stored. Therefore, only the electrical equipment which is freshly installed can transmit broadcast the identification-information acquisition request.

Moreover, in the above described electrical equipment, preferably, the electrical equipment may further comprise, a transmittable-range setting section which sets stepwise a transmittable range where the identification-information acquisition request is transmitted broadcast, and a condition setting section which sets a condition for receiving identification information from another piece of electrical equipment; the start-request reception section receives the identification-information acquisition start request that includes a first setting information for narrowing stepwise a transmittable range where the identification-information acquisition request is transmitted broadcast if the number of pieces of electrical equipment which are stored in the database is a predetermined number or below, and a second setting information for widening stepwise the transmittable range where the identification-information acquisition request is transmitted broadcast if the number of the pieces of electrical equipment which are stored in the database is the predetermined number or above; if the first setting information is included in the identification-information acquisition start request, the transmittable-range setting section should narrow the transmittable range stepwise, and if the second setting information is included in the identification-information acquisition start request, the transmittable-range setting section should widen the transmittable range stepwise; the condition setting section should set, as a condition, whether or not the number of the pieces of identification information which are received by the identification-information reception section reaches a predetermined number that is decided in advance; and if the number of the pieces of identification information which are received by the identification-information reception section reaches the predetermined number that is decided in advance, the identification-information transmission section transmits the identification information on another piece of electrical equipment to the equipment control apparatus.

According to this configuration, the identification-information acquisition start request is received which includes a first setting information for narrowing stepwise a transmittable range where the identification-information acquisition request can be transmitted broadcast if the number of pieces of electrical equipment which are stored in the database is a predetermined number or below, and a second setting information for widening stepwise the transmittable range where the identification-information acquisition request can be transmitted broadcast if the number of the pieces of electrical equipment which are stored in the database is the predetermined number or above. Then, if the first setting information is included in the received identification-information acquisition start request, the transmittable range is set to narrow stepwise. If the second setting information is included in the identification-information acquisition start request, the transmittable range is set to widen stepwise. Sequentially, whether or not the number of the received pieces of identification information has reached a predetermined number that is decided in advance, is set as a condition. If the number of the received pieces of identification information has reached the predetermined number that is decided in advance, the identification information on another piece of electrical equipment is transmitted to the equipment control apparatus.

Therefore, if a small number of pieces of electrical equipment are already stored in a database, the transmittable range where the identification-information acquisition request can be transmitted broadcast is set to narrow stepwise. On the other hand, if a large number of pieces of electrical equipment are already stored in the database, the transmittable range where the identification-information acquisition request can be transmitted broadcast is set to widen stepwise. Thereby, the time of processing which will be taken to obtain identification information on other pieces of electrical equipment can be shortened according to the number of other pieces of electrical equipment which are already installed.

The equipment installation-place setting method, comprises: a communicating step of receiving, from first electrical equipment, identification information on second electrical equipment that is located within a predetermined range from the first electrical equipment, a database controlling step of retrieving, from a database in which installation-place information that indicates an installation place of electrical equipment is stored so as to correspond to identification information on electrical equipment, the installation-place information which corresponds to the identification information on the second electrical equipment which is received in the communicating step, a place-prediction processing step of predicting installation-place information on the first electrical equipment, based on the identification information on the second electrical equipment which is received in the communicating step and the installation-place information which is retrieved in the database controlling step, and a displaying step of displaying the installation-place information which is predicted in the place-prediction processing step.

According to this configuration, identification information on the second electrical equipment that is located within a predetermined range from the first electrical equipment is received from the first electrical equipment. Then, from a database in which installation-place information that indicates an installation place of electrical equipment is stored so as to correspond to the identification information on the electrical equipment, the installation-place information which corresponds to the identification information on the second electrical equipment, is retrieved. Sequentially, installation-place information on the first electrical equipment is predicted based on the identification information on the second electrical equipment and the retrieved installation-place information. Then, the predicted installation-place information is displayed.

Therefore, an installation place of electrical equipment which is newly installed is predicted based upon identification information on the electrical equipment near the newly-installed electrical equipment. Then, a candidate for the predicted installation place is displayed. Thereby, there is no need for the user to become aware of identification information on electrical equipment to be installed. In other words, all the user has to do is to confirm its installation place. In such a way, the disposition place of the newly-installed electrical equipment can be registered in a database.

The equipment installation-place setting method, in which an installation place of electrical equipment is set in an equipment control apparatus, the electrical equipment being communicably connected to the equipment control apparatus which controls the electrical equipment, comprises: an acquisition-request transmitting step of transmitting broadcast an identification-information acquisition request to acquire identification information on another piece of electrical equipment, an identification-information receiving step of, in response to the identification-information acquisition request that is transmitted in the acquisition-request transmitting step, receiving identification information on another piece of electrical equipment within a predetermined range, and an identification-information transmitting step of transmitting, to the equipment control apparatus, the identification information on another piece of electrical equipment that is received in the identification-information receiving step.

According to this configuration, an identification-information acquisition request to acquire identification information on another piece of electrical equipment, is transmitted broadcast. In response to the transmitted identification-information acquisition request, identification information on another piece of electrical equipment within a predetermined range, is received. Then, the received identification information on another piece of electrical equipment is transmitted to the equipment control apparatus.

Therefore, identification information on another piece of electrical equipment near the newly-installed electrical equipment can be acquired. Then, this identification information is transmitted to the equipment control apparatus. Thereby, the installation place of the newly-installed electrical equipment can be predicted.

The computer-readable record medium stores equipment installation-place setting program which allows a computer to function as: a communication section which receives, from first electrical equipment, identification information on second electrical equipment that is located within a predetermined range from the first electrical equipment, a database control section which retrieves, from a database in which installation-place information that indicates an installation place is stored so as to correspond to identification information on electrical equipment, the installation-place information which corresponds to the identification information on the second electrical equipment which is received by the communication section, a place-prediction processing section which predicts installation-place information on the first electrical equipment, based on the identification information on the second electrical equipment which is received by the communication section and the installation-place information which is retrieved by the database control section, and a display section which displays the installation-place information that is predicted by the place-prediction processing section.

According to this configuration, identification information on the second electrical equipment that is located within a predetermined range from the first electrical equipment is received from the first electrical equipment. Then, from a database in which installation-place information that indicates an installation place is stored so as to correspond to the identification information on the electrical equipment, the installation-place information which corresponds to the identification information on the second electrical equipment, is retrieved. Sequentially, installation-place information on the first electrical equipment is predicted based on the identification information on the second electrical equipment and the retrieved installation-place information. Then, the predicted installation-place information is displayed.

Therefore, an installation place of electrical equipment which is newly installed is predicted based upon identification information on the electrical equipment near the newly-installed electrical equipment. Then, a candidate for the predicted installation place is displayed. Thereby, there is no need for the user to become aware of identification information on electrical equipment to be installed. In other words, all the user has to do is to confirm its installation place. In such a way, the disposition place of the newly-installed electrical equipment can be registered in a database.

The computer-readable record medium stores equipment installation-place setting program which is used for electrical equipment that is communicably connected to an equipment control apparatus which controls the electrical equipment, allows a computer to function as an acquisition-request transmission section which transmits broadcast an identification-information acquisition request to acquire identification information on another piece of electrical equipment, an identification-information reception section which, in response to the identification-information acquisition request that is transmitted by the acquisition-request transmission section, receives identification information on another piece of electrical equipment within a predetermined range, and an identification-information transmission section which transmits, to the equipment control apparatus, the identification information on another piece of electrical equipment that is received by the identification-information reception section.

According to this configuration, an identification-information acquisition request to acquire identification information on another piece of electrical equipment, is transmitted broadcast. In response to the transmitted identification-information acquisition request, identification information on another piece of electrical equipment within a predetermined range, is received. Then, the received identification information on another piece of electrical equipment is transmitted to the equipment control apparatus.

Therefore, identification information on another piece of electrical equipment near the newly-installed electrical equipment can be acquired. Then, this identification information is transmitted to the equipment control apparatus. Thereby, the installation place of the newly-installed electrical equipment can be predicted.

The equipment installation-place setting system, in which electrical equipment and an equipment control apparatus that controls the electrical equipment are communicably connected, wherein: the electrical equipment includes, an acquisition-request transmission section which transmits broadcast an identification-information acquisition request to acquire identification information on another piece of electrical equipment, an identification-information reception section which, in response to the identification-information acquisition request that is transmitted by the acquisition-request transmission section, receives identification information on another piece of electrical equipment that is located within a predetermined range from the electrical equipment itself, and an identification-information transmission section which transmits, to the equipment control apparatus, the identification information on another piece of electrical equipment that is located within a predetermined range from the electrical equipment itself that is received by the identification-information reception section; and the equipment control apparatus includes, a communication section which receives the identification information on another piece of electrical equipment that is located within a predetermined range from the electrical equipment which is transmitted by the electrical equipment, a database control section which retrieves, from a database in which installation-place information that indicates an installation place is stored so as to correspond to the identification information on another piece of electrical equipment, the installation-place information which corresponds to the identification information on another piece of electrical equipment which is received by the communication section, a place-prediction processing section which predicts installation-place information on the electrical equipment, based on the identification information on another piece of electrical equipment which is received by the communication section and the installation-place information which is retrieved by the database control section, and a display section which displays the installation-place information that is predicted by the place-prediction processing section.

According to this configuration, in the electrical equipment, an identification-information acquisition request to acquire identification information on another piece of electrical equipment, is transmitted broadcast. In response to the identification-information acquisition request, identification information on another piece of electrical equipment that is located within a predetermined range from the electrical equipment itself, is received. Then, the received identification information on another piece of electrical equipment that is located within a predetermined range from the electrical equipment itself, is transmitted to the equipment control apparatus. In the equipment control apparatus, the identification information on another piece of electrical equipment that is located within a predetermined range from the electrical equipment which is transmitted by the electrical equipment, is received. From a database in which installation-place information that indicates an installation place is stored so as to correspond to the identification information on another piece of electrical equipment, the installation-place information which corresponds to the received identification information on another piece of electrical equipment, is retrieved. Then, installation-place information on the electrical equipment is predicted based on the received identification information on another piece of electrical equipment and the retrieved installation-place information. Next, the predicted installation-place information is displayed.

Therefore, an installation place of electrical equipment which is newly installed is predicted based on identification information on another piece of electrical equipment near the newly-installed electrical equipment. Then, a candidate for the predicted installation place is displayed. Thereby, there is no need for the user to become aware of identification information on electrical equipment to be installed. In other words, all the user has to do is to confirm its installation place. In such a way, the disposition place of the newly-installed electrical equipment can be registered in a database.

An installation place of electrical equipment which is newly installed is predicted based upon identification information on the electrical equipment near the newly-installed electrical equipment. Then, a candidate for the predicted installation place is displayed. Thereby, there is no need for the user to become aware of identification information on electrical equipment to be installed. In other words, all the user has to do is to confirm its installation place. In such a way, the disposition place of the newly-installed electrical equipment can be registered in a database.

This application is based on Japanese patent application Ser. No. 2004-084354, filed in Japan Patent Office on Mar. 23, 2004, the contents of which are hereby incorporated by reference.

Although the present invention has been fully described by way if example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

1. An equipment control apparatus, comprising:
a communication section which receives, from first electrical equipment, identification information on second electrical equipment that is located within a predetermined range from the first electrical equipment,
a database control section which retrieves, from a database in which installation-place information that indicates an installation place of electrical equipment is stored so as to correspond to identification information on electrical equipment, the installation-place information which corresponds to the identification information on the second electrical equipment which is received by the communication section,
a place-prediction processing section which predicts installation-place information on the first electrical equipment, based on the identification information on the second electrical equipment which is received by the communication section and the installation-place information which is retrieved by the database control section, and
a display section which displays the installation-place information that is predicted by the place-prediction processing section.

2. The equipment control apparatus according to claim 1, wherein the place-prediction processing section predicts that among the pieces of installation-place information on the second electrical equipment which are retrieved by the database control section, the largest number of pieces of installation-place information will be the installation-place information on the first electrical equipment.

3. The equipment control apparatus according to claim 1, wherein:
reference equipment whose installation place is specified in advance is predetermined; and
if installation-place information on the reference equipment is included among the pieces of installation-place information on the second electrical equipment which are retrieved by the database control section, the place-prediction processing section predicts that the installation-place information on the reference equipment will be the installation-place information on the first electrical equipment.

4. The equipment control apparatus according to claim 1, further comprising:
an input section which accepts a confirmation input by a user of the installation-place information that is displayed by the display section, and
a confirmation processing section which confirms, using the input section, whether the installation-place information that is predicted by the place-prediction processing section is correct; and
if the confirmation processing section confirms that the installation-place information on the first electrical equipment is correct, the database control section stores the installation-place information in the database.

5. The equipment control apparatus according to claim 1, further comprising a layout-information storage section which stores, in advance, layout information that relates a plurality of installation places to a relative position to each other;
based on the installation-place information which is retrieved by the database control section and the layout information which is stored in the layout-information storage section, the place-prediction processing section predicts a plurality of pieces of information on installation places in which the first electrical equipment is probably installed; and
the display section displays the pieces of installation-place information which are predicted by the place-prediction processing section in order of the probability that the first electrical equipment is installed.

6. The equipment control apparatus according to claim 5, wherein:
the layout-information storage section stores layout information in a matrix format which relates a plurality of installation places to a numeric value that corresponds to a transmittable distance to each other; and
the place-prediction processing section adds the elements which correspond to the lines of each of a plurality of pieces of installation-place information which are retrieved by the database control section, and predicts the installation-place information according to the numeric value of the added elements.

7. The equipment control apparatus according to claim 5, wherein:
the layout-information storage section stores, in advance, layout information which indicates the central coordinates of each of a plurality of installation places; and
the place-prediction processing section calculates the average coordinates of a plurality of pieces of installation-place information which are retrieved by the database control section, calculates the distance between the average coordinates and the central coordinates of each installation place, and predicts the installation-place information according to the calculated distance.

8. The equipment control apparatus according to claim 1, further comprising:
an input section which accepts a confirmation input by a user of the installation-place information that is displayed by the display section, and
a confirmation processing section which confirms, using the input section, whether the installation-place information that is predicted by the place-prediction processing section is correct;
if the confirmation processing section confirms that the installation-place information on the first electrical equipment is correct, the database control section stores the installation-place information in the database;
the equipment control apparatus further comprising a storage-completion information transmission section which transmits, to the first electrical equipment, storage completion information which indicates that the storage of the installation-place information in the database is completed by the database control section.

9. The equipment control apparatus according to claim 1, further comprising:
a start-request transmission section which transmits, to the first electrical equipment, an identification-information acquisition start request to start to acquire the identification information on the second electrical equipment, and
a creation section which creates the identification-information acquisition start request that includes a first setting information for narrowing stepwise a transmittable range where the identification-information acquisition request to acquire the identification information on the second electrical equipment is transmitted broadcast if the number of pieces of electrical equipment which are stored in the database is a predetermined number or below, and a second setting information for widening stepwise the transmittable range where the identification-information acquisition request is transmitted broadcast if the number of the pieces of electrical equipment which are stored in the database is the predetermined number or above.

10. Electrical equipment which is communicably connected to an equipment control apparatus that controls the electrical equipment, comprising:
an acquisition-request transmission section which transmits broadcast an identification-information acquisition request to acquire identification information on another piece of electrical equipment,
an identification-information reception section which, in response to the identification-information acquisition request that is transmitted by the acquisition-request transmission section, receives identification information on another piece of electrical equipment within a predetermined range, and
an identification-information transmission section which transmits, to the equipment control apparatus, the identification information on another piece of electrical equipment that is received by the identification-information reception section.

11. The electrical equipment according to claim 10, further comprising:
a transmittable-range setting section which sets stepwise a transmittable range where the identification-information acquisition request is transmitted broadcast, and.
a condition setting section which sets a condition for receiving identification information from another piece of electrical equipment;
the transmittable-range setting section narrows the transmittable range stepwise;
the condition setting section sets, as a condition, whether or not the number of the pieces of identification information which are received by the identification-information reception section reaches a predetermined number that is decided in advance; and
if the number of the pieces of identification information which are received by the identification-information reception section reaches the predetermined number that is decided in advance, the identification-information transmission section transmits the identification information on another piece of electrical equipment to the equipment control apparatus.

12. The electrical equipment according to claim 10, further comprising:
a transmittable-range setting section which sets stepwise a transmittable range where the identification-information acquisition request is transmitted broadcast, and
a condition setting section which sets a condition for receiving identification information from another piece of electrical equipment;
the transmittable-range setting section widens the transmittable range stepwise;
the condition setting section sets, as a condition, whether or not the number of the pieces of identification information which are received by the identification-information reception section reaches a predetermined number that is decided in advance; and
if the number of the pieces of identification information which are received by the identification-information reception section reaches the predetermined number that is decided in advance, the identification-information transmission section transmits the identification information on another piece of electrical equipment to the equipment control apparatus.

13. The electrical equipment according to claim 10, wherein:
the equipment control apparatus transmits an identification-information acquisition start request to start to acquire the identification information on another piece of electrical equipment;
the electrical equipment further comprising a start-request reception section which receives the identification-information acquisition start request that is transmitted by the equipment control apparatus; and
if the identification-information acquisition start request is received by the start-request reception section, the acquisition-request transmission section transmits broadcast the identification-information acquisition request to acquire the identification information on another piece of electrical equipment.

14. The electrical equipment according to claim 13, further comprising a storage-completion information storage section which stores the storage completion information which indicates that the storage of the installation-place information in the database is completed by the equipment control apparatus; and
if the identification-information acquisition start request is received by the start-request reception section, the acquisition-request transmission section refers to the storage-completion information storage section, and if the storage completion information is not stored, it transmits broadcast the identification-information acquisition request to acquire the identification information on another piece of electrical equipment.

15. The electrical equipment according to claim 13, further comprising:
a transmittable-range setting section which sets stepwise a transmittable range where the identification-information acquisition request is transmitted broadcast, and
a condition setting section which sets a condition for receiving identification information from another piece of electrical equipment;
the start-request reception section receives the identification-information acquisition start request that includes a first setting information for narrowing stepwise a transmittable range where the identification-information acquisition request is transmitted broadcast if the number of pieces of electrical equipment which are stored in the database is a predetermined number or below, and a second setting information for widening stepwise the transmittable range where the identification-information acquisition request is transmitted broadcast if the number of the pieces of electrical equipment which are stored in the database is the predetermined number or above;
if the first setting information is included in the identification-information acquisition start request, the transmittable-range setting section narrows the transmittable range stepwise, and if the second setting information is included in the identification-information acquisition start request, the transmittable-range setting section widens the transmittable range stepwise;
the condition setting section sets, as a condition, whether or not the number of the pieces of identification information which are received by the identification-information reception section reaches a predetermined number that is decided in advance; and
if the number of the pieces of identification information which are received by the identification-information reception section reaches the predetermined number that is decided in advance, the identification-information transmission section transmits the identification information on another piece of electrical equipment to the equipment control apparatus.

16. An equipment installation-place setting method, comprising:
a communicating step of receiving, from first electrical equipment, identification information on second electrical equipment that is located within a predetermined range from the first electrical equipment,
a database controlling step of retrieving, from a database in which installation-place information that indicates an installation place of electrical equipment is stored so as to correspond to identification information on electrical equipment, the installation-place information which corresponds to the identification information on the second electrical equipment which is received in the communicating step,
a place-prediction processing step of predicting installation-place information on the first electrical equipment, based on the identification information on the second electrical equipment which is received in the communicating step and the installation-place information which is retrieved in the database controlling step, and
a displaying step of displaying the installation-place information which is predicted in the place-prediction processing step.

17. An equipment installation-place setting method in which an installation place of electrical equipment is set in an equipment control apparatus, the electrical equipment being communicably connected to the equipment control apparatus which controls the electrical equipment, comprising:
an acquisition-request transmitting step of transmitting broadcast an identification-information acquisition request to acquire identification information on another piece of electrical equipment,
an identification-information receiving step of, in response to the identification-information acquisition request that is transmitted in the acquisition-request transmitting step, receiving identification information on another piece of electrical equipment within a predetermined range, and
an identification-information transmitting step of transmitting, to the equipment control apparatus, the identification information on another piece of electrical equipment that is received in the identification-information receiving step.

18. A computer-readable record medium in which an equipment installation-place setting program wherein the computer-readable record medium in which the equipment installation-place setting program allows a computer to function as:
a communication section which receives, from first electrical equipment, identification information on second electrical equipment that is located within a predetermined range from the first electrical equipment,
a database control section which retrieves, from a database in which installation-place information that indicates an installation place of electrical equipment is stored so as to correspond to identification information on electrical equipment, the installation-place information which corresponds to the identification information on the second electrical equipment which is received by the communication section,
a place-prediction processing section which predicts installation-place information on the first electrical equipment, based on the identification information on the second electrical equipment which is received by the communication section and the installation-place information which is retrieved by the database control section, and
a display section which displays the installation-place information that is predicted by the place-prediction processing section.

19. A computer-readable record medium in which an equipment installation-place setting program which is used for electrical equipment that is communicably connected to an equipment control apparatus which controls the electrical equipment,
wherein the computer-readable record medium in which the equipment installation-place setting program allows a computer to function as:
an acquisition-request transmission section which transmits broadcast an identification-information acquisition request to acquire identification information on another piece of electrical equipment,
an identification-information reception section which, in response to the identification-information acquisition request that is transmitted by the acquisition-request transmission section, receives identification information on another piece of electrical equipment within a predetermined range, and
an identification-information transmission section which transmits, to the equipment control apparatus, the identification information on another piece of electrical equipment that is received by the identification-information reception section.

20. An equipment installation-place setting system in which electrical equipment and an equipment control apparatus that controls the electrical equipment are communicably connected, wherein:
the electrical equipment includes,
an acquisition-request transmission section which transmits broadcast an identification-information acquisition request to acquire identification information on another piece of electrical equipment,
an identification-information reception section which, in response to the identification-information acquisition request that is transmitted by the acquisition-request transmission section, receives identification information on another piece of electrical equipment that is located within a predetermined range from the electrical equipment itself, and
an identification-information transmission section which transmits, to the equipment control apparatus, the identification information on another piece of electrical equipment that is located within a predetermined range from the electrical equipment itself that is received by the identification-information reception section; and
the equipment control apparatus includes,
a communication section which receives the identification information on another piece of electrical equipment that is located within a predetermined range from the electrical equipment which is transmitted by the electrical equipment,
a database control section which retrieves, from a database in which installation-place information that indicates an installation place of electrical equipment is stored so as to correspond to the identification information on another piece of electrical equipment, the installation-place information which corresponds to the identification information on another piece of electrical equipment which is received by the communication section,
a place-prediction processing section which predicts installation-place information on the electrical equipment, based on the identification information on another piece of electrical equipment which is received by the communication section and the installation-place information which is retrieved by the database control section, and
a display section which displays the installation-place information that is predicted by the place-prediction processing section.
